(19) United States
(12) Patent Application Publication
(10) Pub. No.: US 2024/0166787 A1
(43) Pub. Date: May 23, 2024

(54) COMPOSITIONS, POLYMERIC FILMS, AND ARTICLES INCLUDING A CHEMICAL BLOWING AGENT AND/OR A CROSSLINKER HAVING A PHOTODEGRADABLE LINKAGE, FOAM COMPOSITIONS, METHODS, AND CROSSLINKERS

(71) Applicant: 3M INNOVATIVE PROPERTIES COMPANY, St. Paul, MN (US)

(72) Inventors: Joshua M. Fishman, St.Louis Park, MN (US); Bryan T. Whiting, St. Paul, MN (US); Kathleen S. Shafer, Woodbury, MN (US); Nicholas L. Untiedt, Minneapolis, MN (US); Michael E. Griffin, Maplewood, MN (US)

(21) Appl. No.: 18/548,637

(22) PCT Filed: Mar. 10, 2022
(86) PCT No.: PCT/IB2022/052173

§ 371 Date: Sep. 1, 2023

Related U.S. Application Data
(60) Provisional application No. 63/174,781, filed on Apr. 14, 2021.

(51) Int. Cl. C08F 220/18; C08F 2/50; C08F 220/06; C08F 220/20; C08F 220/28; C08F 222/22; C08G 59/24; C08J 5/18; C08J 9/00; C08J 9/10; C08K 5/23; C08K 5/3462; C09J 5/08; C09J 7/30; C09J 133/08; C09J 163/00

(52) U.S. Cl. CPC C08F 220/1804; C08F 2/50; C08F 220/06; C08F 220/1811; C08F 220/20; C08F 220/281; C08F 222/22; C08G 59/245; C08J 5/18; C08J 9/0061; C08J 9/102; C08K 5/23; C08K 5/3462; C09J 5/08; C09J 7/30; C09J 133/08; C09J 163/00; C08J 2201/026; C08J 2203/04; C08J 2333/10; C08J 2363/02; C09J 2301/312; C09J 2301/416; C09J 2301/502; C09J 2400/24

(57) ABSTRACT

Compositions are provided including a free-radically reactive component, a photoradical generator, and either a crosslinker having a photodegradable linkage or a chemical blowing agent, an epoxy component, and a photoacid generator. Polymeric films including reaction products of the compositions are also provided. A debondable article including a polymeric film containing a crosslinker having a photodegradable linkage is further provided, as well as a method of debonding the article. Foam compositions are also provided, including foamed matrices including the reaction products of the compositions. Further, articles and foam adhesives are provided including a substrate and a composition or foam composition disposed on the substrate. A method is additionally provided, including dispensing a composition onto a substrate; subjecting the composition to light radiation having a wavelength band of 50 nanometers or less to initiate polymerization of the composition; and subjecting the composition to light and/or heat radiation, wherein the light radiation has at least one wavelength that is outside the wavelength band of the light radiation of step b) to initiate foaming of the composition. A crosslinker is further provided, including a photodegradable linkage.

### FIELD

The present disclosure relates to dispensable multi-stage compositions, polymeric films, foam compositions, articles, and methods of forming the foam compositions and articles.

### BACKGROUND

Foams are porous materials that are composed of gas filled networks or chambers segmented by a solid matrix. The properties of foamed materials are governed by the composition of the matrix material and the morphology of its cellular structure. Isocyanate-based formulations are a class of dispensable resin that currently can be used to make foams at room temperature, but these materials are becoming undesirable due to toxicity concerns.

### SUMMARY

Compositions, polymeric films, debondable articles, foam compositions, articles, methods, and crosslinkers are provided.

In a first aspect, a composition is provided. The composition comprises a) a free-radically reactive component; b) a crosslinker comprising a photodegradable linkage that releases nitrogen gas upon decomposition; and c) a photoradical generator.

In a second aspect, a crosslinker is provided. The crosslinker is of Formula II:

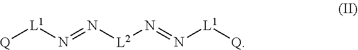

In Formula II, Q is independently an ethylenically unsaturated group; L¹ is independently a divalent (hetero)hydrocarbylene group; and L² is a multivalent (hetero)hydrocarbylene group.

In a third aspect, another composition is provided. The composition comprises a) a free-radically reactive component; b) an epoxy component; c) a chemical blowing agent; d) a photoradical generator; and e) a photoacid generator.

In a fourth aspect, an article is provided. The article comprises a substrate and the composition according to the first aspect or the third aspect disposed on the substrate.

In a fifth aspect, a polymeric film is provided. The polymeric film comprises a reaction product of a composition comprising: a) a free-radically reactive component; b) a crosslinker comprising a photodegradable linkage; and c) a photoradical generator. The photodegradable linkage of the crosslinker is present in the reaction product.

In a sixth aspect, another polymeric film is provided. The polymeric film comprises a reaction product of a composition comprising: a) a free-radically reactive component; b) an epoxy component; c) a chemical blowing agent; d) a photoradical generator; and e) a photoacid generator. The chemical blowing agent is present in the reaction product.

In a seventh aspect, a foam composition is provided. The foam composition comprises: a) a foamed polymeric matrix comprising a reaction product of a composition comprising: i) a free-radically reactive component; ii) a crosslinker comprising a photodegradable linkage; and iii) a photoradical generator. The foam composition further comprises b) fragments of the crosslinker; and c) fragments of the photoradical generator.

In an eighth aspect, another foam composition is provided. The foam composition comprises: a) a foamed thermoset polymeric matrix comprising a reaction product of a composition comprising: i) a free-radically reactive component; ii) an epoxy component; iii) a chemical blowing agent; iv) a photoradical generator; and v) a photoacid generator. The foam composition also comprises b) fragments of the chemical blowing agent; c) fragments of the photoradical generator; and d) fragments of the photoacid generator.

In a ninth aspect, a foam adhesive is provided. The foam adhesive comprises a substrate and the foam composition according to the seventh aspect or the eighth aspect disposed on the substrate.

In a tenth aspect, a method of making a foam composition comprising a foamed polymeric matrix is provided. The method comprises: a) dispensing a composition onto a substrate; b) subjecting the composition to light radiation having a wavelength band of 50 nanometers or less, thereby initiating polymerization of the composition; and c) subjecting the composition to light and/or heat radiation, wherein the light radiation has at least one wavelength that is outside the wavelength band of the light radiation of step b), thereby initiating foaming of the composition.

In an eleventh aspect, a debondable article is provided. The debondable article comprises:

i) a first substrate comprising a major surface; ii) a second substrate comprising a major surface; and iii) the polymeric film according to the fifth aspect, wherein the polymeric film is adhered to the major surface of the first substrate and to the major surface of the second substrate.

In a twelfth aspect, a method of debonding an article is provided. The method comprises: i) obtaining the debondable article according to the eleventh aspect; ii) subjecting the debondable article to light radiation, thereby initiating gas release from the polymeric film and forming a weakened polymeric layer having a lower density or a smaller number of crosslinks; and iii) applying a force to the article such that the weakened polymeric layer undergoes selective cohesive failure.

Accordingly, compositions, polymeric films, debondable articles, foam compositions, foam adhesives, and methods of making foam compositions are provided with respect to compositions including a crosslinker having a photodegradable linkage. Additionally, compositions, polymeric films, foam compositions, foam adhesives, and methods of making foam compositions are provided with respect to compositions including a free-radically reactive compound, a photoradical generator, a chemical blowing agent, an epoxy component, and a photoacid generator. Advantageously, alternatives to isocyanate-based formulations can be applied, cured, and foamed at room temperature, leading to foamed polymeric constructions.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a schematic cross-sectional view of a multi-step process for making exemplary articles, preparable according to the present disclosure.

FIG. 2 is a flow chart of an exemplary method of making a foam composition.

FIG. 3 is a flow chart of an exemplary method of debonding an article.

FIG. 4 is a schematic cross-sectional view of a multi-step process for making an exemplary debondable article and debonding the article.

While the above-identified figures set forth several embodiments of the disclosure, other embodiments are also contemplated, as noted in the description. The figures are not necessarily drawn to scale. In all cases, this disclosure presents the invention by way of representation and not limitation.

### DETAILED DESCRIPTION

Foams are porous materials that are composed of gas filled networks or chambers segmented by a solid matrix. The properties of foamed materials are governed by the composition of the matrix material and the morphology of its cellular structure. Control over the morphology of a foam's cell structure is often governed by the foaming method to which the matrix material is subjected. Historically, foaming has been achieved using either physical blowing agents (PBAs), which take advantage of the change in volume that occurs during first order phase transitions such as evaporation and sublimation or when a gas experiences a decrease in pressure; thermally activated chemical blowing agents (CBAs), which are molecules that decompose to gaseous species when heated; or expandable microspheres (EMSs), sold by Nouryon and Chase Corporation. EMSs are composed of gas or liquid hydrocarbon PBAs inside a polymer shell. When heated past the glass transition temperature (T_{g}) of the shell, the shell becomes malleable and expands due to the internal pressure of the heated PBA inside. This process leads to a syntactic foam filled with polymer shells that are expanded but not ruptured. Useful categories of blowing agents include, for instance, a volatile liquid, a gas, a chemical compound, and a plurality of expandable microspheres. Volatile liquid and gas blowing agents expand when heated and then tend to escape from the flowable composition, leaving voids behind, to form the foam composition. Chemical compound blowing agents decompose and at least a portion of the decomposition product(s) expand and then escape from the mixture, leaving voids behind.

Extant dispensable foamable resins typically require a heating element in the dispenser to activate a blowing agent during application, or a post-application bake is needed to generate the foam. As mentioned above, isocyanate-based formulations are a class of dispensable resin that currently can be used to make foams at room temperature, yet such materials have disadvantages. Compositions according to at least certain embodiments of the present disclosure are dual actinic resin systems that can be cured and foamed using independent wavelengths of light. One way this can be achieved is by combining blue-light sensitive photoradical generators (e.g., photoinitiators) with CBAs that decompose when exposed to UV light in radically curable compositions. The photo-triggered foaming compositions (e.g., resins) can be applied, cured, and foamed at room temperature. In some instances, the viscosity is low enough to enable jetting of the compositions before cure, however higher viscosity formulations can also be used.

In general, curing a matrix resin with a wavelength of light that does not overlap with the CBA absorbance spectrum allows independent control over resin cure and CBA decomposition. The decoupling of curing and foaming reactions enables the foam structure to be tuned more easily than if a single wavelength of light is used. Additionally, this method gives the option of performing the curing step and the foaming step concurrently or stepwise. This is useful, for instance, for on-demand debonding applications where foaming or bond scission in crosslinkers weakens the interface and eases bond separation. Aspects of the present disclosure advantageously enable the production of foam tapes or adhesives, sealants, insulation, panels, or other foamed articles at room temperature without generating frothing or using isocyanates or hollow particle additives.

Some known foam compositions contain pre-expanded fillers (e.g., expandable or pre-expanded polymeric microspheres or hollow glass microspheres), such as the compositions described in US Application Publication No. 2019/0276711 (Anderson et al.) and International Application Publication No. WO 2019/229695 (Volp et al.). In these cases, the foams are syntactic foams with rigid polymer or glass shells defining the cell walls. Foam compositions containing pre-expanded polymer or glass microspheres have the disadvantage that they cannot be activated on-demand. Additionally, the size of certain microspheres may prevent dispensing via some methods, such as inkjet printing, where the filler would clog the dispenser opening (e.g., nozzle). In contrast, compositions according to at least certain embodiments of the present disclosure lack a polymer shell lining the cell walls, which is desirable because the foam compositions will be softer and more compressible than compositions containing polymeric or glass microspheres.

### Glossary

As used herein, a “monomer” is a single, one unit molecule capable of combination with itself or other monomers to form oligomers or polymers; an “oligomer” is a component having 2 to 9 repeat units; and a “polymer” is a component having 10 or more repeat units.

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched saturated divalent hydrocarbon radical having from three to twelve carbon atoms, e.g., methylene, ethylene, propylene, 2-methylpropylene, pentylene, hexylene, and the like.

As used herein, “alkenyl” refers to a monovalent linear or branched unsaturated aliphatic group with one or more carbon-carbon double bonds, e.g., vinyl. Unless otherwise indicated, the alkenyl groups typically contain from one to twenty carbon atoms.

As used herein, “alkenediyl” refers to a straight-chained, branched, or cyclic divalent unsaturated aliphatic group, e.g., —CH═CH—, —CH═C(CH₃)CH₂—, —CH═CHCH₂—, and the like. Unless otherwise indicated, the alkenediyl groups typically contain from one to twenty carbon atoms.

As used herein, “amidine” refers to the functional group R¹C(NR²)NR³, wherein the R groups are independently selected from H, C1-C8 alkyl groups, hydroxyl terminated alkyl groups, and carboxyl terminated alkyl groups.

As used herein, “heteroalkyl” refers to an alkyl group substituted with a heteroatom. The heteroatoms may be pendent atoms, such as fluorine, chlorine, bromine, or iodine, or catenary atoms such as nitrogen, oxygen, boron, or sulfur.

As used herein, “heterocyclic” refers to a cyclic group substituted with a heteroatom. The heteroatoms are caternary atoms such as nitrogen, oxygen, boron, or sulfur. The heterocyclic group is a group derived from a heterocycle in which at least one of the atoms configuring the ring is a heteroatom, and typically is a group with which a carbon atom or a heteroatom configuring the heterocycle can be bonded to the main chain either directly or through another group. The heterocycle may contain one or more types of heteroatoms that are the same or different in the same ring. The heterocycle may contain an unsaturated bond (unsaturated heterocycle) or may not contain an unsaturated bond (saturated heterocycle). The heterocycle may be an aromatic heterocycle (a pyridine ring or an imidazole ring, for example), or may be a non-aromatic heterocycle (a pyrazine ring, for example). Each of the rings configuring the heterocycle may be a three-membered ring, a four-membered ring, a five-membered ring, a six-membered ring, a seven-membered ring, an eight-membered ring, a nine-membered ring or a ten-membered ring. A three-membered ring, four-membered ring, five-membered ring, or six-membered ring is preferable, and a five-membered ring or a six-membered ring is more preferable. The heterocycle includes a maximum of 24 members (e.g., atoms configuring all of the one or more rings). As the heterocycle, a monocyclic or bicyclic heterocycle having from 5 to 10 atoms configuring a ring is favorable, and a monocyclic heterocycle having from 5 or 6 atoms configuring the ring is particularly preferable. The number of heteroatoms present in the same ring of a heterocycle can be from 1 to 3, and 1 or 2 is more preferable. A nitrogen atom or a sulfur atom is preferable, and a nitrogen atom is more preferable. The heterocycle may have, as heteroatoms, two nitrogen atoms, or one nitrogen atom and one sulfur atom.

As used herein, the term “ethylenically unsaturated” refers to a group that comprises at least one carbon-carbon double bond, including at least one of (1) a vinyl group (CH₂═CH—); (2) a (meth)acryloyloxy group (CH₂═CR—(CO)—O—), wherein R is hydrogen or methyl); or (3) a (meth)acrylamido group (CH₂═CR—(CO)—NH—), wherein R is hydrogen or methyl; or a maleic group (—(CO)—(CH₂═CH₂)—(CO)—).

As used herein, the term “hydrocarbylene” refers to a divalent radical of a hydrocarbon. The hydrocarbylene can be linear, branched, cyclic, or a combination thereof. The hydrocarbylene can be saturated, partially unsaturated, or unsaturated and can have up to 40 carbon atoms, up to 20 carbon atoms, up to 10 carbon atoms, up to 6 carbon atoms, or up to 4 carbon atoms. It often has at least 1 carbon atom or at least 2 carbon atoms. The hydrocarbyl is often an alkylene, arylene, aralkylene, or alkarylene.

As used herein, the term “catenated heteroatom” means a heteroatom replaces one or more carbon atoms in a carbon chain. The heteroatom is typically oxygen, sulfur, or nitrogen.

As used herein, the term “heterohydrocarbylene” refers to a hydrocarbylene with at least one but not all of the catenated carbon atoms replaced with a heteroatom selected from oxygen —O—, carbonyl —CO—, oxycarbonyl —O—(CO)—, carbonyloxy, —(CO)—O—, carbonylimino —(CO)—NH—, iminocarbonyl —NH—(CO)—, sulfur (—S—), and nitrogen (e.g., —NH—). The term “(hetero)hydrocarbylene” refers to a hydrocarbylene, a heterohydrocarbylene, or both.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl groups, and linked by an aliphatic segment if containing two or more groups. As used herein, “(meth)acrylate-functional compounds” are compounds that include, among other things, a (meth)acrylate moiety.

As used herein, “crown ether” refers to a macrocyclic polyether comprising dimethylene oxide units which can coordinate to a centrally located metal atom via the oxygen atoms of the ethers, thereby functioning as electron donors to the metal atom. Some crown ethers include 18-crown-6 ether and 15-crown-5 ether. As used herein “aza-crown ether” refers to nitrogen substituted equivalents of the crown ethers or mixed, nitrogen and oxygen substituted crown ether equivalents, such as —NR—, where R is hydrogen or an alkyl group.

As used herein, “thermoplastic” refers to a polymer that flows when heated sufficiently above its glass transition point and becomes solid when cooled.

As used herein, “thermoset” refers to a polymer that permanently sets upon curing and does not flow upon subsequent heating. Thermoset polymers are typically chemically crosslinked polymers.

As used herein, “set” refers to a crosslinking process, where the polymer chains are connected to form a 3D network through either covalent bonds (chemical crosslinking) or ionic/hydrogen bonding (physical crosslinking).

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Compositions Including a Crosslinker with a Photodegradable Linkage

In a first aspect, a composition is provided. The composition comprises:
a) a free-radically reactive component;
b) a crosslinker comprising a photodegradable linkage that releases nitrogen gas upon decomposition; and
c) a photoradical generator.

Preferably, there is at least one wavelength of light at which the photoradical generator degrades that is different from the wavelengths of light at which the photodegradable linkage of the crosslinker degrades.

In a second aspect, a crosslinker is provided. The crosslinker is of Formula II:

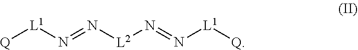

In Formula II, Q is independently an ethylenically unsaturated group; L¹ is independently a divalent (hetero)hydrocarbylene group; and L² is a multivalent (hetero)hydrocarbylene group. In some cases, L² is divalent.

The components of the composition, which optionally includes the crosslinker of Formula (II), are described in detail below.

### Free-Radically Reactive Component

The free-radically reactive component provides at least a portion of a matrix of the composition. Often, the free-radically reactive component comprises a monomer, a crosslinker, or both, comprising at least one ethylenically unsaturated group, e.g., comprising a vinyl group, an alkenyl group, a (meth)acrylic group, a (meth)acryl group, or combinations thereof. Multifunctional monomers can also be referred to as crosslinkers. In select embodiments, the free-radically reactive component comprises a (meth)acrylate component. Typically, the free-radically reactive component exhibits an overall glass transition temperature (T_{g}) of 23° C. or less, which advantageously contributes to a sufficiently low modulus composition for successful foaming once at least partially cured.

Suitable free-radically reactive components include monofunctional monomers such as phenoxy ethyl(meth)acrylate, phenoxy-2-methylethyl(meth)acrylate, phenoxyethoxyethyl(meth)acrylate, 3-hydroxy-2-hydroxypropyl(meth)acrylate, benzyl(meth)acrylate, phenylthio ethyl acrylate, 2-naphthylthio ethyl acrylate, 1-naphthylthio ethyl acrylate, 2,4,6-tribromophenoxy ethyl acrylate, 2,4-dibromophenoxy ethyl acrylate, 2-bromophenoxy ethyl acrylate, 1-naphthyloxy ethyl acrylate, 2-naphthyloxy ethyl acrylate, phenoxy 2-methylethyl acrylate, phenoxyethoxyethyl acrylate, 3-phenoxy-2-hydroxy propyl acrylate, 2,4-dibromo-6-sec-butylphenyl acrylate, 2,4-dibromo-6-isopropylphenyl (meth)acrylate, benzyl (meth)acrylate, phenyl (meth)acrylate, tetrahydrofurfuryl (meth)acrylate, alkoxylated tetrahydrofurfuryl acrylate, ethoxylated nonyl phenol (meth)acrylate, alkoxylated lauryl (meth)acrylate, alkoxylated phenol (meth)acrylate, stearyl (meth)acrylate, tetrahydrofurfuryl (meth)acrylate, lauryl (meth)acrylate, isodecyl (meth)acrylate, isooctyl (meth)acrylate, octadecyl (meth)acrylate, tridecyl (meth)acrylate, ethoxylated (4) nonyl phenol (meth)acrylate, caprolactone (meth)acrylate, cyclic trimethylolpropane formal (meth)acrylate, 3,3,5-trimethylcyclohexyl (meth)acrylate, dicyclopentadienyl (meth)acrylate, isobutyl (meth)acrylate, n-butyl (meth)acrylate, t-butyl(meth)acrylate, ethyl hexyl (meth)acrylate, isobornyl (meth)acrylate, methyl(meth)acrylate, C1-C20 alkyl (meth)acrylates, 2,4,6-tribromophenyl (meth)acrylate, and the (meth)acrylate monomers described in U.S. Pat. No. 8,137,807 (Clapper et al.), incorporated herein by reference in its entirety.

Suitable free-radically reactive components are often monomers, oligomers, or low molecular weight polymers that contain multiple reactive functional groups. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate,1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates. Other classes of useful free-radically reactive components are multifunctional components comprising functional groups selected from acrylamides, acrylonitriles, (meth)acrylonitriles, vinyl esters, vinyl ethers, n-vinyl pyrrolidinone, n-vinyl caprolactam, vinyl aromatics, ethylene, styrenics, malonates, or any combination thereof.

Suitable free-radically polymerizable multifunctional components include di-, tri-, or other poly-acrylates and methacrylates such as glycerol diacrylate, ethoxylated bisphenol A dimethacrylate (D-zethacrylate), tetraethylene glycol dimethacrylate (TEGDMA), polyethyleneglycol dimethacrylate (PEGDMA), glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate,1,2,4-butanetriol trimethacrylate, 1,4-cyclohexanediol diacrylate, 1,4-butanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis [1-(3-acryloxy-2-hydroxy)]-p-propoxyphenyldimethylmethane, and trishydroxyethyl-isocyanurate trimethacrylate; bis-acrylates of polyesters (e.g., methacrylate-terminated polyesters); the bis-acrylates and bis-methacrylates of polyethylene glycols of molecular weight 200-500, copolymerizable mixtures of acrylated monomers such as those in U.S. Pat. No. 4,652,274 (Boettcher et al.), and acrylated oligomers such as those of U.S. Pat. No. 4,642,126 (Zador et al.); polyfunctional (meth)acrylates comprising urea or amide groups, such as those of EP2008636 (Hecht et al). The non-degradable crosslinking agent can comprise one or more poly(meth)acrylates, for example, di-, tri-, tetra- or pentafunctional monomeric or oligomeric aliphatic, cycloaliphatic or aromatic acrylates or methacrylates.

Examples of suitable aliphatic poly(meth)acrylates having more than two (meth)acrylate groups in their molecules are the triacrylates and trimethacrylates of hexane-2,4,6-triol; glycerol or 1,1,1-trimethylolpropane; ethoxylated or propoxylated glycerol or 1,1,1-trimethylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate.

Another suitable class of free-radically reactive component includes aromatic di(meth)acrylate compounds and trifunctional or higher functionality (meth)acrylate compounds.

Trifunctional or higher functionality meth(acrylates) can be tri-, tetra- or pentafunctional monomeric or oligomeric aliphatic, cycloaliphatic or aromatic acrylates or methacrylates.

Examples of suitable aliphatic tri-, tetra- and pentafunctional (meth)acrylates are the triacrylates and trimethacrylates of hexane-2,4,6-triol; glycerol or 1,1,1-trimethylolpropane; ethoxylated or propoxylated glycerol or 1,1,1-tri-methylolpropane; and the hydroxyl-containing tri(meth)acrylates which are obtained by reacting triepoxide compounds, for example the triglycidyl ethers of said triols, with (meth)acrylic acid. It is also possible to use, for example, pentaerythritol tetraacrylate, bistrimethylolpropane tetraacrylate, pentaerythritol monohydroxytriacrylate or -methacrylate, or dipentaerythritol monohydroxypentaacrylate or -methacrylate. In some embodiments, tri(meth)acrylates comprise 1,1-trimethylolpropane triacrylate or methacrylate, ethoxylated or propoxylated 1,1,1-trimethylolpropanetriacrylate or methacrylate, ethoxylated or propoxylated glycerol triacrylate, pentaerythritol monohydroxy triacrylate or methacrylate, or tris(2-hydroxy ethyl) isocyanurate triacrylate. Further examples of suitable aromatic tri(meth)acrylates are the reaction products of triglycidyl ethers of trihydroxy benzene and phenol or cresol novolaks containing three hydroxyl groups, with (meth)acrylic acid.

In some cases, a multifunctional free-radically reactive component comprises diacrylate and/or dimethacrylate esters of aliphatic, cycloaliphatic or aromatic diols, including 1,3- or 1,4-butanediol, neopentyl glycol, 1,6-hexanediol, dodecane diol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S. In some cases, a free-radically reactive component described herein comprises one or more higher functional acrylates or methacrylates such as dipentaerythritol monohydroxy pentaacrylate or bis(trimethylolpropane)tetraacrylate.

Free-radically reactive components may also include compounds comprising mercapto groups. The chain extension goes by thiol-ene type reactions.

In some embodiments, at least one free-radically reactive component present is not an acrylate. Some such suitable monomers include for instance and without limitation, (meth)acrylamides, (meth)acrylonitriles, vinyl esters, vinyl ethers, n-vinyl pyrrolidinone, n-vinyl caprolactam, vinyl aromatics, vinyl pyridines, vinyl sulfonic acid, vinyl sulfonamides, vinyl sulfonates, vinyl phosphates, styrenics, malonates, or any combination thereof.

Collectively, one or more free-radically reactive components may be present in the composition in an amount of 5 wt. % or greater, based on the total weight of polymerizable components of the composition, 10 wt. % or greater, 15 wt. % or greater, 20 wt. % or greater, 25 wt. % or greater, 30 wt. % or greater, 35 wt. % or greater, 40 wt. % or greater, 45 wt. % or greater, or 50 wt. % or greater; and 99 wt. % or less, 90 wt. % or less, 85 wt. % or less, 80 wt. % or less, 75 wt. % or less, 70 wt. % or less, or 65 wt. % or less, based on the total weight of polymerizable components of the composition.

### Crosslinker Comprising a Photodegradable Linkage

The crosslinker including a photodegradable linkage provides the dual purpose of crosslinking reactive components together when a composition is cured, and a means of foaming the (at least partially) cured material when the linkage is photodegraded via light radiation. Although the presence of crosslinks in a cured reaction product provides stiffness to the composition, the use of degradable crosslinks results in a softer composition during and following degradation, which tends to make the foaming more successful.

Often, the photodegradable linkage includes a functional group that is the same as (or similar to) a functional group present in a chemical blowing agent, which is known to decompose to gaseous species when heated. For instance, in any embodiment, the photodegradable linkage of the crosslinker comprises at least one functional group selected from the group consisting of an azo group, a tetrazole group, a triazole group, a triazene group, and a triazolethione group. The functional group is preferably an azo group or a triazene group. It is noted that “triazine” is an alternate spelling for “triazene” when three nitrogen atoms are present in an aromatic structure.

In any embodiment, the crosslinker is of Formula (I) or Formula (II):

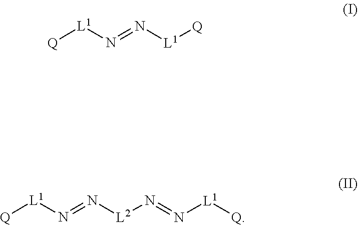

In each of Formula (I) and Formula (II), Q is independently an ethylenically unsaturated group and L¹ is independently a divalent (hetero)hydrocarbylene group.

In Formula (II), L² is a multivalent (hetero)hydrocarbylene group.

In some cases, Q is independently a (meth)acryloyloxy group of the formula CH₂═CR—(CO)—O—, wherein R is hydrogen or methyl.

In some cases, L¹ of Formula (I) is of the formula —R⁴—R⁵—R⁶—, wherein R⁴ is a (hetero)alkylene, R⁵ is a group of formula —X—(CO)—, wherein X is —NH— or —O—, and R⁶ is a (hetero)alkylene. In some cases, R⁴ is an alkylene, R⁵ is —X—(CO)—, and R⁶ is an alkylene. The (hetero)alkylene can be linear, branched, cyclic, or a combination thereof.

In some cases, Q of Formula (I) is independently a methacryloyl group, a (meth)acrylamidyl group, a vinyl group, or a styryl group.

In one case of Formula (I), Q is of the formula CH₂═CH—(CO)—O— and L¹ is of the formula —CH₂—CH₂—NH—(CO)—C(CH₃)₂—. In this case, the crosslinker of Formula (I) is of the following Formula (III):

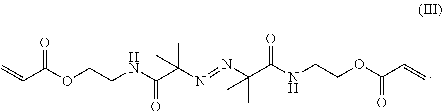 [SMILES: C=CC(=O)OCCNC(=O)C(C)(C)/N=N/C(C)(C)C(=O)NCCOC(=O)C=C]

In one case of Formula (I), Q is of the formula CH₂═C(CH₃)—(CO)—O—, one L¹ is of the formula —CH₂C₆H₄—, and the other L¹ is of the formula —CH₂—CH₂—N(CH₃)—. In this case, the crosslinker of Formula (I) is of the following Formula (IV):

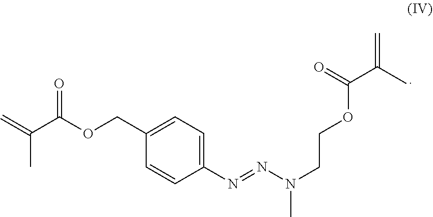 [SMILES: C=C(C)C(=O)OCCN(C)/N=N/c1ccc(COC(=O)C(=C)C)cc1]

In some cases, L¹ of Formula (II) is an arylene, aralkylene, or alkarylene. In some cases, L¹ of Formula (II) is an aralkylene or an alkarylene.

In some cases, L² of Formula (II) is multivalent and is an aza-crown ether, an oligoethyleneimine, or a polyethyleneimine. In some cases, L² of Formula (II) is a branched oligoethyleneimine or polyethyleneimine containing ethyleneimine units in which the amino group is independently primary, secondary, or tertiary.

In some cases, L² of Formula (II) is a divalent heterocyclic group. Often, the heteroatom is N. In some cases, L² of Formula (II) is of the formula —C₄H₄N₂—, such as a pyrazine ring.

In some cases, L² of Formula (II) is an aza-crown ether, such as 1,4,7-triazacylononane, 4,13-diaza-18-crown-6, cyclam (i.e., 1,4,8,11-tetraazacyclotetradecane), or hexaaza-18-crown-6; a conjugate of an azo-crown ethers, such as Plerixafor; (i.e., 1-[[4-(1,4,8,11-tetrazacyclotetradec-1-ylmethyl)phenyl]methyl]-1,4,8,11-tetrazacyclotetradecane); a mixed ether-amine ligand, such as [2.2.2]Cryptand (i.e., 4,7,13,16,21,24-hexaoxa-1,10-diazabicyclo[8.8.8]hexacosane) or KRYPTOFIX 22 (i.e., 1,7,10,16-tetraoxa-4,13-diazacyclooctadecane); or a linear or branched polyethylene imine.

In some cases, Q of Formula (II) is independently selected from an acryloyl group and a vinyl group.

In one case of Formula (II), Q is of the formula CH₂═C(CH₃)—(CO)—O—, L¹ is of the formula —CH₂C₆H₄₋, and L² is of the formula —C₄H₄N₂—. In this case, the crosslinker of Formula (II) is of the following Formula (V):

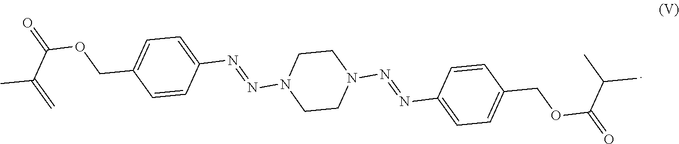 [SMILES: C=C(C)C(=O)OCc1ccc(/N=N/N2CCN(/N=N/c3ccc(COC(=O)C(C)C)cc3)CC2)cc1]

### Photoradical Generator

Photoradical generators (e.g., free-radical initiators) often comprise an actinic radiation-activated initiator. Photoradical generators can be Norrish Type I or Norrish Type II. If a Type II photoinitator is used, often a second synergist is included that is able to have a radical abstracted by the photoinitator and subsequently initiate the polymerization. It is understood that if a Type II photoinitator is used in combination with the second additive the combined packed is considered the photoradical generator. Suitable free-radical initiators typically comprise photoinitiator groups selected from acyl phosphine oxide, alkyl amine acetophenone, benzil ketal, xanthone, isopropylthioxanthone, pentadione, thioxanthrequinone, 2,3-butanedione, phenanthrenequinone, ethylanthraquinone, 1,4-chrysenequinone, camphorequinone, pyrene, hydroxy-acetophenone, benzophenone, organic or inorganic peroxide, a persulfate, titanocene complex, azo, or combinations thereof. When the initiator groups include a persulfate or a Type II initiator an alkyl amine may be added as a synergist or accelerator such as tetramethylethylenediamine, 2-ethylhexyl-(4-N,N-dimethyl amino)benzoate or Ethyl-4-(dimethylamino)benzoate.

Examples of suitable photoradical generators comprising a one component system where two radicals are generated by cleavage, typically contain a moiety selected form benzoin ether, acetophenone, benzoyl oxime or acyl phosphine. Suitable exemplary photoradical generators are those available under the trade designation OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl] -2-hydroxy-2-methyl-1-propane-1-one (OMNIRAD 2959), 2-benzyl-2-dimethylamino-1-(4-morpholinophenyl)butanone (OMNIRAD 369), 2-methyl-1-14-(methylthio)phenyl1-2-morpholinopropan-1-one (OMNIRAD 907), 2-hydroxy-2-methyl-1-phenyl propan-1-one (OMNIRAD 1173), 2,4,6-trimethylbenzoyldiphenylphosphine oxide (OMNIRAD TPO), and 2,4,6-trimethylbenzoylphenyl phosphinate (OMNIRAD TPO-L) and IRGACURE from Ciba and include bis(η⁵-2,4-cyclopentadien-1-yl)-bis(2,6-difluoro-3-(1H-pyrrol-1-yl)-phenyl)titanium (IRGACURE 784). Often, the photoradical generator comprises a visible light initiated free-radical photoinitiator (e.g., bis(2,4,6 trimethylbenzoyl)phenylphosphineoxide (OMNIRAD 819) or bis(η⁵-2,4-cyclopentadien-1-yl)-bis(2,6-difluoro-3-(1H-pyrrol-1-yl)-phenyl)titanium (IRGACURE 784)). Additional suitable photoradical generators include for example and without limitation, Oligo[2-hydroxy-2-methyl-1-[4-(1-methylvinyl)phenyl]propanone] ESACURE ONE (Lamberti S.p.A., Gallarate, Italy), 2-hydroxy-2-methylpropiophenone, benzyl dimethyl ketal, 2-methyl-2-hydroxypropiophenone, benzoin methyl ether, benzoin isopropyl ether, anisoin methyl ether, aromatic sulfonyl chlorides, photoactive oximes, TEGO A18 sold by Evonik, and combinations thereof.

A photoradical generator may be present in a composition in an amount of 0.1 wt. % or greater, based on the total weight of the composition, 0.25 wt. % or greater, 0.5 wt. % or greater, or 1 wt. % or greater; and 10 wt. % or less, 9 wt. % or less, 8 wt. % or less, 7 wt. % or less, 6 wt. % or less, 5 wt. % or less, 4 wt. % or less, 3 wt. % or less, or 2 wt. % or less, based on the total weight of the composition in an amount of up to about 5% by weight, based on the total weight of the composition. In some cases, a photoradical generator is present in an amount of about 0.1-5% by weight, based on the total weight of the composition.

### Chemical Blowing Agent

Optionally, the composition further comprises at least one chemical blowing agent. Upon heating, the chemical blowing agent assists in generating voids to form the foam composition. In some embodiments, more than one blowing agent may be used in certain foam compositions, and the blowing agent may comprise any one or more of an unencapsulated chemical blowing agent or an encapsulated chemical blowing agent, plus optionally an unencapsulated physical blowing agent, or expandable microspheres.

The chemical blowing agent (CBA) is preferably a solid particulate blowing agent and is typically selected from an azocompound, a diazocompound, a sulfonyl hydrazide, a sulfonyl semicarbazide, a tetrazole, a nitrosocompound, an acyl sulfonyl hydrazide, a hydrazone, a thiatriazole, an azide, a sulfonyl azide, an oxalate, a thiatrizine dioxide, isotaoic anhydride, a triazene, a triazolethione, a thiohydroxamate, a thiazolethione, or any combination thereof. Examples of suitable chemical blowing agents include for instance and without limitation, 1,1-azodicarboxamide (AZO), p-toluene sulfonyl hydrazide (Hydrazine), p-toluenesulfonyl 10 semicarbazide (PTSC), and 5H-phenyl tetrazole (5PT). AZO is one of the most common CBAs due to its high gas yield upon degradation and low cost. AZO decomposes when heated at or above 190° C. (with optimal temperatures between 190° C. and 230° C.), and gives off 220 mL/g nitrogen and carbon monoxide in the process. Hydrazine is another common CBA, and decomposes when heated at or above 150° C. (with optimal temperatures between 165° C. and 180° C.), and gives off 120 to 130 mL/g of ammonia, hydrogen, and nitrogen in the process. 5H-phenyl tetrazole is also a suitable CBA, and decomposes when heated at or above 215° C. (with optimal temperatures between 240° C. and 250° C.), and gives off 195 to 215 mL/g of nitrogen in the process. An additional suitable CBA is isatoic anhydride, which decomposes when heated at or above 210° C. (with optimal temperatures between 230° C. and 250° C.), and gives off 115 mL/g of carbon dioxide in the process.

Chemical blowing agents that are also thermal free-radical initiators include those commercially available from Chemours Co. (Wilmington, DE) under the VAZO trade designation including VAZO 88 (1,1′-azo-bis(cyclohexanecarbonitrile), VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)). Other azo-based chemical blowing agents that are also thermal free-radical initiators include those commercially available from FUJIFILM Wake Pure Chemical Corporation (Richmond, VA) including V-70 (2,2′-Azobis(4-methoxy-2,4-dimthylvaleronitrile), V-501 (4,4′-Azobis(4-cyanovaleric acid), V-601 (Dimethyl 2,2′-azobis(2-methylpropionate), VA-086 (2,2′-Azobis[2-methyl-N-(2-hydroxyethyl)propionamiole]), VAm-110 (2,2′-Azobis (N-butyl-2-methylpropionamide)), VA-044 (2,2′-Azobis[2-(2-imidazolin-2-yl)propane]dihydrochloride), VA-061 (2,2′-Azobis[2-(2-imidazolin-2-yl)propane]), V-50 (2,2′-Azobis(2-methylpropionamidine)dihydrochloride), and VA-057 (2,2′-Azobis[N-(2-carboxyethyl)-2-methylpropionamidine]tetrahydrate). FUJIFILM also provides macro azo blowing agents including VPS-1001 (4,4-Azobis(4-cyanovaleric acid),polymer with alpha, ornega.-bis(3-aminopropyl)polydimethylsiloxane) and VPE-0201 (4,4′-Azobis(4-cyanopentanoicacid. Polyethyleneglycolpolymer) Azo-based compounds give off one mole of nitrogen per mole of compound used.

Other chemical blowing agents that are also free radical initiators include O-esters of thiohydroxamates and thiazolethiones as described in U.S. Pat. No. 6,894,082 (Brantl et al.).

When included, the chemical blowing agent is typically present in an amount of 0.1 wt. % or greater, based on the total weight of the composition, 0.25 wt. % or greater, 0.5 wt. % or greater, 1 wt. % or greater, 2 wt. % or greater, 3 wt. % or greater, 4 wt. % or greater, 5 wt. % or greater, 6 wt. % or greater, 7 wt. % or greater, 8 wt. % or greater, 9 wt. % or greater, or 10 wt. % or greater; and 20 wt. % or less, 19 wt. % or less, 18 wt. % or less, 17 wt. % or less, 16 wt. % or less, 15 wt. % or less, 14 wt. % or less, 13 wt. % or less, 12 wt. % or less, or 11 wt. % or less, based on the total weight of the composition. Stated another way, in some embodiments the chemical blowing agent is present in an amount of 0.5 wt. % to 20 wt. %, inclusive; 0.5 to 15 wt. %, 0.5 wt. % to 10 wt. %, 1 to 8 wt. %, or 10 wt. % to 17 wt. %, inclusive, of the total composition.

In some embodiments, the optional chemical blowing agent comprises an unencapsulated chemical blowing agent, which means that that chemical blowing agent is free of a shell disposed on its exterior. In select embodiments, a suitable unencapsulated chemical blowing agent comprises a synthetic azo-based compound. An advantage of using a synthetic azo-based compound is that it can also add free-radicals to the composition when the chemical blowing agent decomposes to supplement the free-radicals provided by the free-radical initiator.

In some embodiments, the optional chemical blowing agent comprises a particle encapsulated within a shell. The shell typically comprises an uncrosslinked thermoplastic material. Often, the uncrosslinked thermoplastic material exhibits a complex viscosity of 3,700 Pa·s or greater at a decomposition temperature of the chemical blowing agent particle. Useful uncrosslinked thermoplastic materials for the shell of encapsulated CBAs, additional materials co-encapsulated with the CBAs, methods of preparing encapsulated CBAs, and the like include, for instance, the encapsulated CBAs described in co-owned International Application Publication No. WO2020/254916 (Fishman et al.), incorporated herein by reference in its entirety. Encapsulation of CBAs in uncrosslinked (e.g., thermoplastic) polymer shells can lead to foam structures, after the CBA core decomposes and the shells rupture to release the formed gas, with decreased cell size and increased cell density and homogeneity as compared to unencapsulated CBAs. Encapsulation of a chemical blowing agent by a polymer shell provides a composite particle, in which the coating layer surrounds the core particle as a shell layer. Stated differently, such composite particles are core-shell particles.

### Additives

The composition optionally includes one or more additives. Useful additives include for instance and without limitation, a solvent, an oligomeric or polymeric additive, or any combination thereof.

Suitable solvents include at least one of the organic solvents of hydrocarbons or halogenated hydrocarbons (e.g., toluene, cyclohexane, petroleum ether, chloroform), lower alcohols (e.g., methanol, ethanol, propanol, and isopropanol), esters of aliphatic acids (e.g., ethyl acetate and methyl acetate), ethers (e.g., tetrahydrofuran, dioxane), organic nitriles (e.g., acetonitrile), and ketones (e.g., acetone and methyl ethyl ketone). The solvents can be used singly or in admixture. One skilled in the art can readily determine which solvent to use, and its amount.

Suitable polymeric and/or oligomeric additives are polymers or oligomers which are soluble in the monomers of the composition. Such polymeric and/or oligomeric additives may be free-radically reactive or non-reactive. Suitable polymeric and/or oligomeric additives include polyurethanes, polyesters, polyethers, polyolefins, poly(meth)acrylates, synthetic rubbers, vinyl polymers, polyamides, and phenolics. Examples of free-radically reactive additives include, but are not limited to, GENOMER 4215, GENOMER 4188/EHA, GENOMER 4212, GENOMER 3414 available from Rahn AG, Zurich, Switzerland; Sartomer CN-986, Sartomer CN-1963, Sartomer CN-981, Sartomer CN-991, Sartomer CN-996 available from Arkema Inc., King of Prussia, PA, USA; PHOTOMER 5429, PHOTOMER 6024, PHOTOMER 6210 available from IGM Resins USA Inc., Charlotte, NC, USA; ELVACITE 2008C, ELVACITE 2697, ELVACITE 2013 available from ChemPoint, Inc., Bellevue, WA, USA. Examples of non-reactive additives include, but are not limited to, MOWITAL B14S, MOWITAL B2OHH, MOWITAL B3OHH, MOWITAL B6OH, KURARITY LA3320, KURARITY LA2330, KURARITY LA2250, KURARITY LA2270, available from Kuraray Co., Ltd. Tokyo, Japan; LEVAMELT 900, LEVAMELT 800, LEVAMELT 700, available from Arlanxeo USA LLC, Orange TX, USA; KRATON D1117, KRATON D1119, KRATON D1111, available from Kraton Polymers US LLC, Houston, TX, USA.

In preparing compositions as described herein, the components are thoroughly mixed using any suitable means known by those of ordinary skill in the art. For example, the composition may be mixed by use of a (e.g., Brabender, SpeedMixer) mixer, extruder, kneader, sonicator or the like. In some embodiments, at least some of the components are also heated (e.g., subjected to a temperature ranging from 30° C.-220° C., inclusive) as long as no chemical blowing agent or crosslinker with a photodegradable linkage is heated to a high enough temperature to cause degradation.

In some embodiments, the composition exhibits a viscosity at ambient temperature (e.g., 23-25 degrees Celsius) of 40 centipoises (cP) or less, 35 cP or less, 30 cP or less, 25 cP or less, 20 cP or less, 15 cP or less, or 10 cP or less; and 1 cP or greater, 2 cP or greater, 3 cP or greater, 5 cP or greater, 7 cP or greater, 9 cP or greater, 12 cP or greater, or 16 cP or greater, at a frequency of 1 Hertz (Hz). In some embodiments, the composition exhibits a viscosity of 1 cP to 40 cP. The viscosity is the dynamic viscosity and can be measured using a vibrating viscometer, which applies oscillating vibrations to the composition and monitors the damping effects of the composition (e.g., by monitoring power input, decay time of oscillations, or changes in resonated frequency).

### Compositions Including an Epoxy Component, Photoacid Generator, and Chemical Blowing Agent

In a third aspect, another composition is provided. The composition comprises:
a) a free-radically reactive component;
b) an epoxy component;
c) a chemical blowing agent;
d) a photoradical generator; and
e) a photoacid generator.

In some cases, the chemical blowing agent is photodegradable, plus optionally there is at least one wavelength of light at which the photoradical generator degrades that is different from the wavelengths of light at which the chemical blowing agent degrades.

Each of the free-radically reactive component, chemical blowing agent, photoradical generator, and optional additive(s) (e.g., solvent, degradable crosslinker, and/or an oligomeric or polymeric additive) is as described above in detail with respect to the first aspect. In some cases, the chemical blowing agent is thermally degradable. The composition can also be prepared as described above with respect to the first aspect, and have the same viscosity.

The additional components (e.g., the epoxy component and photoacid generator) are described below in detail.

### Epoxy Component

The composition comprises at least one epoxy component, such as one or more epoxy resins, which are reactive molecules characterized by epoxide functional groups. The inclusion of an epoxy component advantageously contributes to forming cured materials that are toughened and have a non-tacky interpenetrating network (e.g., interpenetration of the epoxy with the free-radically reactive component). Epoxy resins or epoxides that are useful in the composition may be any organic compound having at least one oxirane ring polymerizable by a ring opening mechanism. Preferably, the epoxy component comprises a glycidyl group, which is an epoxy group attached to a methyl group.

The epoxy resins can be monomeric or polymeric, and aliphatic, cycloaliphatic, heterocyclic, aromatic, hydrogenated, or mixtures thereof. Preferred epoxides contain more than 1.5 epoxide groups per molecule and preferably at least 2 epoxide groups per molecule.

The epoxy resin can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacrylate polymer or copolymer), or a mixture thereof. Epoxide-containing materials include compounds having the general formula:

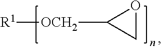

where R¹ is an alkyl, alkyl ether, or aryl group and n ranges from 1 to 6.

Epoxy resins include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylme thane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Other useful epoxy resins are polyhydric phenolic formaldehyde condensation products as well as polyglycidyl ethers that contain as reactive groups only epoxy groups or hydroxy groups. Useful curable epoxy resins are also described in various publications including, for example, “Handbook of Epoxy Resins” by Lee and Nevill, McGraw-Hill Book Co., New York (1967), and Encyclopedia of Polymer Science and Technology, 6, p. 322 (1986).

The choice of epoxy resin can depend upon the intended end use of the composition. For example, epoxides with flexible backbones may be desired where a greater amount of ductility is needed in the bond line. Materials such as diglycidyl ethers of bisphenol A and diglycidyl ethers of bisphenol F can help impart desirable (e.g., structural) adhesive properties upon curing, while hydrogenated versions of these epoxies may be useful for compatibility with substrates having oily surfaces.

Examples of commercially available epoxides useful in the present disclosure include diglycidyl ethers of bisphenol A (e.g., those available under the trade names EPON™ 828, EPON™ 1001, EPON™ 1004, EPON™ 2004, EPON™ 1510, and EPON™ 1310 from Momentive Specialty Chemicals, Inc., Waterford, NY and those under the trade designations D.E.R.™ 331, D.E.R.™ 332, D.E.R.™ 334, and D.E.N.™ 439 available from Dow Chemical Co., Midland, MI); diglycidyl ethers of bisphenol F (that are available, e.g., under the trade designation ARALDITE™ GY 281 available from Huntsman Corporation); silicone resins containing diglycidyl epoxy functionality; flame retardant epoxy resins (e.g., that are available under the trade designation D.E.R.™ 560, a brominated bisphenol type epoxy resin available from Dow Chemical Co.); and 1,4-butanediol diglycidyl ethers.

Epoxy containing compounds having at least one glycidyl ether terminal portion, and preferably, a saturated or unsaturated cyclic backbone may be added to the composition as reactive diluents. Reactive diluents may be added for various purposes such as to aid in processing, e.g., to control the viscosity in the composition as well as during curing, improve flexibility of the cured composition, and/or improve compatibility of the materials in the composition.

Examples of reactive diluents include: diglycidyl ether of cyclohexanedimethanol, diglycidyl ether of resorcinol, p-tert-butyl phenyl glycidyl ether, cresyl glycidyl ether, diglycidyl ether of neopentyl glycol, triglycidyl ether of trimethylolethane, triglycidyl ether of trimethylolpropane, triglycidyl p-amino phenol, N,N′-diglycidylaniline, N,N,N′N′-tetraglycidyl meta-xylylene diamine, and vegetable oil polyglycidyl ether. Reactive diluents are commercially available as HELOXY™ 107 and CARDURA™ N10 from Momentive Specialty Chemicals, Inc., Waterford, NY.

The composition preferably contains one or more epoxy resins having an epoxy equivalent weight of from 50 g/eq to 750 g/eq. More preferably, the composition contains one or more epoxy resins having an epoxy equivalent weight of from 300 g/mol to 1200 g/mol. Even more preferably, the composition contains two or more epoxy resins, wherein at least one epoxy resin has an epoxy equivalent weight of from 150 g/eq to 250 g/eq, and at least one epoxy resin has an epoxy equivalent weight of from 500 g/eq to 600 g/eq.

The composition can include one or more epoxy resins in an amount of at least 10, at least 20, at least 25, at least 30, at least 35, at least 40, at least 50 parts, or at least 55 parts by weight, based on the 100 parts total weight of polymerizable components of the composition. In desirable embodiments, the one or more epoxy resins are present in an amount of up to 45 parts, up to 50 parts, up to 60 parts, up to 65 parts, up to 75 parts, or up to 80 parts by weight, based on the 100 parts total weight of polymerizable components in the composition.

### Photoacid Generator

Photoacid generators are molecules that generate acids when radiated by light. The generated acid initiates cure of the epoxy component. The photoacid generator in the composition can comprise an iododium salt, a sulfonium salt, or a combination thereof. The photoacid generator can be an ionic photoacid generator. Ionic photoacid generators include onium salts, such as bis(4-t-butylphenyl) iodonium hexafluoroantimonate (FP5034™ from Hampford Research Inc., Stratford, CT), a mixture of triarylsulfonium salts (diphenyl(4-phenylthio) phenylsufonium hexafluoroantimonate, bis(4-(diphenylsulfonio)phenyl)sulfide hexafluoroantimonate) available as Syna PI6976™ from Synasia Metuchen, NJ, (4-methoxyphenyl)phenyl iodonium triflate, bis(4-fert-butylphenyl) iodonium camphorsulfonate, bis(4-tert-butylphenyl) iodonium hexafluoroantimonate, bis(4-tert-butylphenyl) iodonium hexafluorophosphate, bis(4-tert-butylphenyl) iodonium tetraphenylborate, bis(4-tert-butylphenyl) iodonium tosylate, bis(4-tert-butylphenyl) iodonium triflate, ([4-(octyloxy)phenyl]phenyliodonium hexafluorophosphate), ([4-(octyloxy)phenyl]phenyliodonium hexafluoroantimonate), (4-isopropylphenyl)(4-methylphenyl)iodonium tetrakis(pentafluorophenyl) borate (available as Rhodorsil 2074™ from Bluestar Silicones, East Brunswick, NJ), bis(4-methylphenyl) iodonium hexafluorophosphate (available as Omnicat 440™ from IGM Resins Bartlett, IL), [4-(2-hydroxy-1-tetradecycloxy)phenyl]phenyl iodonium hexafluoroantimonate, triphenyl sulfonium hexafluoroantimonate (available as CT-548™ from Chitec Technology Corp. Taipei, Taiwan), diphenyl(4-phenylthio)phenylsufonium hexafluorophosphate, bis(4-(diphenylsulfonio)phenyl)sulfide bis(hexafluorophosphate), diphenyl(4-phenylthio)phenylsufonium hexafluoroantimonate, bis(4-(diphenylsulfonio)phenyl)sulfide hexafluoroantimonate, and blends of these triarylsulfonium salts available from Synasia, Metuchen, NJ as SYNA™ PI-6992 and SYNA™ PI-6976 for the PF₆ and SbF₆ salts, respectively. Similar blends of ionic photoacid generators are available from Aceto Pharma Corporation, Port Washington, NY under the tradenames UVI-6992 and UVI-6976.

Generally, the photoacid generator is present in an amount of at least 0.001 parts, at least 0.01 parts, at least 0.05 parts, at least 0.1 parts, at least 0.2 parts, or at least 0.25 parts by weight relative to 100 parts by weight of total polymerizable components in the composition. The photoacid generator can be present in an amount of up to 5 parts, up to 3 parts, up to 2 parts, up to 1 part, up to 0.5 parts, or up to 0.1 parts by weight relative to 100 parts by weight of total polymerizable components in the composition.

### Articles

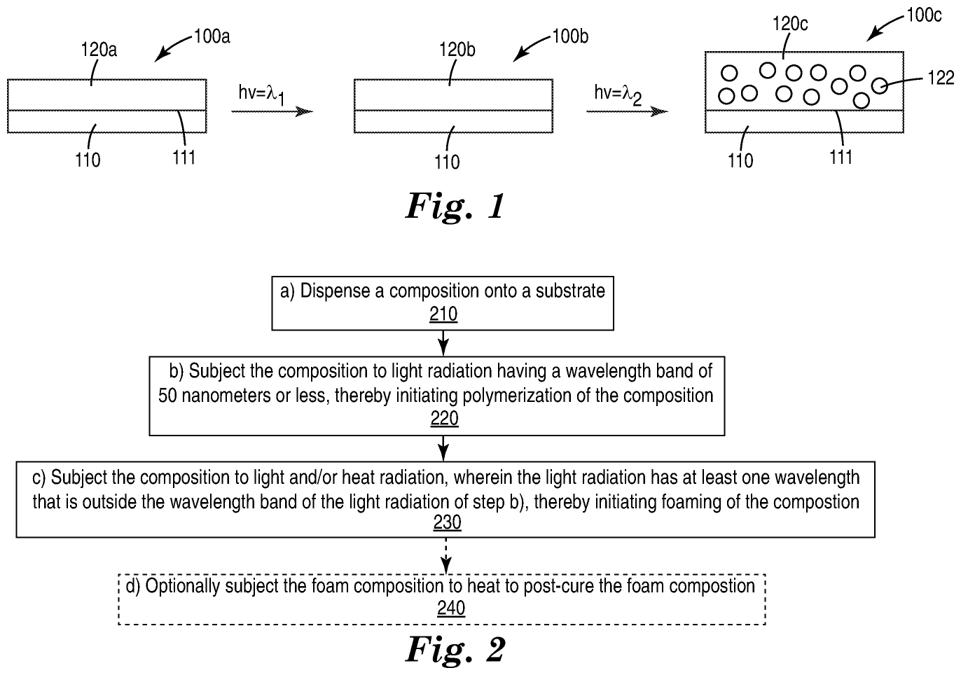

In a fourth aspect, an article is provided. The article comprises a substrate and the composition according to the first aspect or the third aspect disposed on the substrate. Referring to FIG. 1, a schematic cross-sectional view is provided of an article 100a comprising a substrate 110 having a (e.g., uncured) composition 120a disposed on a major surface 111 of the substrate 110. The article 100a may be further processed to form at least partially cured articles/adhesives/foams, such as described in other aspects below. The substrate 110 can be first treated with an adhesion promotor.

### Polymeric Films

In a fifth aspect, a polymeric film is provided. The polymeric film comprises a reaction product of a composition comprising: a) a free-radically reactive component; b) a crosslinker comprising a photodegradable linkage; and c) a photoradical generator. The photodegradable linkage of the crosslinker is present in the reaction product. Accordingly, a polymeric film may be provided by obtaining a composition according to the first aspect described in detail above and at least partially curing the composition. Curing of the composition can be initiated by subjecting the composition to actinic radiation having a wavelength at which the photoradical generator generates photoradicals. The actinic radiation selected does not effectively initiate degradation of the photodegradable linkage of the crosslinker. One example includes employing a visible light photoinitiator as the photoradical generator and radiating the composition with light having one or more wavelengths of a minimum of 450 nanometers (and optionally greater than 450 nm). The at least partially cured polymeric film should contain fragments of the photoradical generator.

In a sixth aspect, another polymeric film is provided. The polymeric film comprises a reaction product of a composition comprising: a) a free-radically reactive component; b) an epoxy component; c) a chemical blowing agent; d) a photoradical generator; and e) a photoacid generator. The chemical blowing agent is present in the reaction product. Accordingly, a polymeric film may be provided by obtaining a composition according to the second aspect described in detail above and at least partially curing the composition. Curing of the composition can be initiated by subjecting the composition to actinic radiation having a wavelength at which the photoradical generator generates photoradicals. The actinic radiation selected does not effectively initiate degradation of the chemical blowing agent and preferably does not initiate generation of acid from the photoacid generator. Accordingly, the reaction product includes a product of reaction of the free-radically reactive component and the photoradical generator, but usually not the photoacid generator or the epoxy component. In some embodiments, the polymeric film has glass transition temperature (T_{g}) that may be below room temperature (e.g., below 23-25 degrees Celsius). As above, radiating the composition with light having a minimum wavelength of 450 nm is one example of suitable initiation of curing of the composition. The at least partially cured polymeric film should contain fragments of the photoradical generator.

In some cases of each of the fifth aspect or the sixth aspect, the reaction product is partially cured, while in other cases, the reaction product is fully cured. Often, the reaction product of the fifth aspect is fully cured, while the reaction product of the sixth aspect is typically only partially cured.

### Foam Compositions

In a seventh aspect, a foam composition is provided. The foam composition comprises:
a) a foamed polymeric matrix, wherein the polymeric matrix comprises a reaction product of a composition comprising:
   i) a free-radically reactive component;
   ii) a crosslinker comprising a photodegradable linkage; and
   iii) a photoradical generator
b) fragments of the crosslinker; and
c) fragments of the photoradical generator.

Accordingly, a foam composition may be provided by obtaining a composition according to the first aspect described in detail above, at least partially curing the composition, and foaming the reaction product. During foaming, the crosslinker that contains a photodegradable linkage undergoes chain scission, enabling the modulus of the reaction product to be dynamically tuned to better accommodate the foam cell structure. Additionally, a decrease in modulus or crosslink density can also aid in the separation of an adhesive bond. It is possible that all the crosslinks get broken during foaming and the radicals do not recombine, in which case, the foamed polymeric matrix is a thermoplastic material. In cases in which a portion of the crosslinks remain after foaming and/or some of the radicals do recombine, the foamed polymeric matrix is a thermoset material. The photodegradable crosslinker can serve as the only foaming agent or may be supplemented by one or more CBAs.

In an eighth aspect, another foam composition is provided. The foam composition comprises:
a) a foamed thermoset polymeric matrix, wherein the thermoset polymeric matrix comprises a reaction product of a composition comprising:
   i) a free-radically reactive component;
   ii) an epoxy component;
   iii) a chemical blowing agent;
   iv) a photoradical generator; and
   v) a photoacid generator;
b) fragments of the chemical blowing agent;
c) fragments of the photoradical generator; and
d) fragments of the photoacid generator.

Accordingly, a foam composition may be provided by obtaining a composition according to the second aspect described in detail above, at least partially curing the composition, and foaming the reaction product.

Suitable methods for forming the foam compositions of the seventh and eighth aspects are described in further detail below with respect to the tenth aspect. The foaming process decomposes (at least a portion of) each of the crosslinker comprising a photodegradable linkage, the chemical blowing agent, and the photoradical generator, if present in the particular composition, so that the foam composition includes fragments of each of the listed components that are present in the foam composition. For instance, many azo initiators having the same general structure decompose to release nitrogen and form the fragments shown in the scheme below:

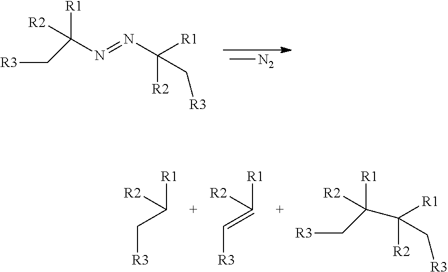

In the above scheme, R1 may be selected from —CN, —COOR, or —CONR4R5, wherein R2 and R3 may be independently selected from H, linear alkyl groups, cyclic alkyl groups, heteroalkyl groups, heterocyclic groups, amidine groups, hydroxyl terminated alkyl groups, or carboxyl terminated alkyl groups; wherein R is H or a C1-C4 alkyl; wherein R4 is a C1-C4 alkylene; and wherein R5 is a C1-C4 alkyl, H, or —OH.

For instance, fragments of OMNIRAD 651 include methylbenzoate, benzaldehyde, benzil, and acetophenone; fragments of OMNIRAD 819 include 2,4,6-trimethylbenzaldehyde and phenyl phosphine oxide species; fragments of IRGACURE 784 include titanocene complexes, cyclopentene derivatives, and 2,6-difluoro-3-(1H-pyrrol-1-yl)-phenyl derivatives; and fragments of OMNIRAD 369 include 4-morpholine benzaldehyde. Fragments of crosslinker comprising a photodegradable linkage, a chemical blowing agent, and/or a photoradical generator can be detected, for instance, by infrared or UV-Vis spectroscopy of the foam composition or mass spectroscopy of the foam or extractables.

In some embodiments in which an encapsulated chemical blowing agent was employed, the encapsulation shell is present as a plurality of particulates distributed (e.g., dispersed) in the foam matrix. The particulates are typically remnants of shells of the composite particles after they rupture during the foaming process. In certain embodiments, the shell particulates are present as a blend with the foamed polymer matrix. There may potentially also be some chemical blowing agent particles remaining in the foam composition that did not decompose during the foaming process, which may be identified by image analysis of a cross-section of the foam composition using scanning electron microscopy (SEM).

In some embodiments, the foam composition comprises a “closed cell” foam, which means that the foam contains substantially no connected cell pathways that extend from one outer surface through the material to another outer surface. A closed cell foam can include up to about 10% open cells, within the meaning of “substantially” no connected cell pathways. Stated another way, a closed cell foam composition comprises 90% or greater closed cells, 92% or greater closed cells, 95% or greater closed cells, or 98% or greater closed cells.

Foam cells can be characterized by image analysis of a cross-section using SEM. Various properties of the foam compositions can include, for instance, cell size, cell size distribution, cell density, and cell aspect ratio. In certain embodiments, the foam composition has a unimodal cell size distribution, whereas in other embodiments the foam composition has a multimodal cell size distribution.

Typically, the foamed polymeric matrix exhibits an average cell size of 1 millimeter or less and 20 micrometer or greater. In certain embodiments, the foam composition comprises an average cell size of 1 millimeter or less, 900 micrometers or less, 800 micrometers or less, 700 micrometers or less, 600 micrometers or less, 500 micrometers or less, 400 micrometers or less, or 300 micrometers or less; and 20 micrometers or greater, 25 micrometers or greater, 30 micrometers or greater, 50 micrometers or greater, 75 micrometers or greater, 100 micrometers or greater, 125 micrometers or greater, 150 micrometers or greater, 175 micrometers or greater, 200 micrometers or greater, 225 micrometers or greater, or 250 micrometers or greater. In an embodiment, the foam composition has an average cell size of 250 to 750 micrometers.

In some cases, the foam composition has an advantageously small thickness, such as an average thickness of 1 centimeter (cm) or less; 900 millimeters (mm) or less, 800 mm or less, 700 mm or less, 600 mm or less, 500 mm or less, 400 mm or less, 300 mm or less, 200 mm or less, 100 mm or less, 1 mm or less, or 900 micrometers or less; and an average thickness of 25 micrometers or greater, 35 micrometers or greater, 50 micrometers or greater, 75 micrometers or greater, 100 micrometers or greater, 125 micrometers or greater, 150 micrometers or greater, 175 micrometers or greater, 200 micrometers or greater, 250 micrometers or greater, 300 micrometers or greater, 400 micrometers or greater, 500 micrometers or greater, 600 micrometers or greater, 700 micrometers or greater, 800 micrometers or greater; 1.5 mm or greater, 3 mm or greater, 5 mm or greater, 10 mm or greater, 25 mm or greater, 50 mm or greater, or 75 mm or greater. Stated another way, an average thickness of 1 centimeter or less and 25 micrometers or greater. The ability to prepare foam compositions having such thicknesses is advantageous because it is typically challenging to make foams on the thinner end when using thermally activated CBAs.

### Foam Adhesives

In a ninth aspect, a foam adhesive is provided. The foam adhesive comprises a substrate and the foam composition according to the seventh aspect or the eighth aspect disposed on the substrate.

Referring again to FIG. 1, a foam adhesive 100c comprises a substrate 110 and the foam composition 120c disposed on the substrate 110 (e.g., on a major surface 111 of the substrate). In this illustration, the foam composition 120c comprises closed cells 122.

In some embodiments, the foam adhesive comprises two substrates, with the foam disposed between the substrates. For instance, referring to FIG. 4, article 400c comprises a first substrate 410, a foam (e.g., an adhesive foam) 420c disposed on the first substrate 410, and a second substrate 412 disposed on the foam 420c.

The foam adhesive may be formed according to the methods of the tenth aspect described in detail below.

### Process of Making Foam Compositions

In a tenth embodiment, a method of making a foam composition is provided. The method comprises:
a) dispensing a composition onto a substrate;
b) subjecting the composition to light radiation having a wavelength band of 50 nanometers or less, thereby initiating polymerization of the composition; and
c) subjecting the composition to light and/or heat radiation, wherein the light radiation has at least one wavelength that is outside the wavelength band of the light radiation of step b), thereby initiating foaming of the composition.

In some cases, step b) may be performed at least partially prior to step c).

Referring back to FIG. 1, the method comprises dispensing a composition 120a onto (e.g., a major surface 111 of) a substrate 110; subjecting the composition to light radiation (e.g., comprising a wavelength of λ₁), thereby initiating polymerization of the composition. The at least partial polymerization results in an article 100b comprising a polymeric reaction product 120b (of the composition 120a) disposed on the substrate 110. The method further comprises subjecting the composition (i.e., at least partially cured polymeric reaction product) 120b to light radiation (e.g., comprising a wavelength of λ₂), thereby initiating foaming of the composition. The foaming results in an article 100c comprising a foam composition 120c disposed on the major surface 111 of the substrate 110.

Referring to FIG. 2, stated another way, the method comprises the Step 210 to a) dispense a composition onto a substrate; Step 220 to b) subject the composition to light radiation having a wavelength band of 50 nanometers or less, thereby initiating polymerization of the composition; and Step 230 to c) subject the composition to light and/or heat radiation, wherein the light radiation has at least one wavelength that is outside the wavelength band of the light radiation of step b), thereby initiating foaming of the composition.

In some cases, the method further comprises the Step 240 to d) optionally subject the foam composition to heat to post-cure the foam composition. Such a post-cure bake can last for at least 1 minute, at least 2 minutes, at least 3 minutes, or at least 5 minutes. On the upper end, the post-cure bake may be sustained up to 24 hours, up to 16 hours, up to 12 hours, up to 8 hours, up to 4 hours, up to 2 hours, up to 35 minutes, up to 25 minutes, or up to 15 minutes. The temperature of the post-cure bake can be, for example, at least 35° C., at least 70° C., or at least 90° C. The temperature can be up to 180° C., up to 150° C., or up to 120° C.

In some embodiments, the composition comprises:
i) a free-radically reactive component;
ii) a crosslinker comprising a photodegradable linkage; and
iii) a photoradical generator.

More particularly, in such embodiments the composition is according to the first aspect, discussed in detail above. Further, the method prepares foam compositions according to the seventh aspect described in detail above.

In some embodiments, the composition comprises:
i) a free-radically reactive component;
ii) an epoxy component;
iii) a chemical blowing agent;
iv) a photoradical generator; and
v) a photoacid generator.

More particularly, in such embodiments the composition is according to the second aspect described in detail above. Further, the method prepares foam compositions according to the eighth aspect described in detail above.

In some embodiments, the composition comprises:
i) a free-radically reactive component;
ii) a photoradical generator; and
iii) a chemical blowing agent.

Various methods for dispensing compositions are suitable for at least certain embodiments of the method. More particularly, the method may include jetting the composition out of a nozzle onto the substrate. Alternatively, the composition can be applied by a pipette applicator or other standing coating or dispensing techniques. The composition typically coats at least a portion of the substrate, and up to the entire surface of the substrate, depending on the application.

Useful actinic light sources include ultraviolet (“UV”) light and visible light sources. For this application, preferred light sources have a controlled spectral output where the distribution of wavelength is fairly narrow (or “substantially monochromatic”) and centered about a characteristic wavelength λ₁ such as a wavelength corresponding to a peak intensity. Other distributions of wavelengths, including polymodal distributions, may be feasible, as long as light source provides a wavelength distribution comprising a band of wavelengths that is at most 50 nanometers wide. In some cases, the actinic light source is a broadband light source comprising a filter to provide the band of wavelengths that is at most 50 nanometers wide. Optionally, the band of wavelengths is at most 40 nanometers wide, at most 35 nanometers wide, at most 30 nanometers wide, at most 25 nanometers wide; and 2 nanometers wide or greater, 3 nanometers wide or greater, 4 nanometers wide or greater, 5 nanometers wide or greater, 7 nanometers wide or greater, 10 nanometers wide or greater, 12 nanometers wide or greater, 15 nanometers wide or greater, 17 nanometers wide or greater, or 20 nanometers wide or greater.

One useful class of actinic light sources uses light emitting diodes (“LED”). LED-based UV sources are advantageous because they are capable of generating UV light over a much narrower wavelength range compared with other UV light sources such as black lights and mercury lamps. Such LED sources are commercially available, for example, the LUXEON Z ES

Series 450 nm LEDs available from Lumileds Holding B.V. (Schipol, the Netherlands), or the AC Series 365 nm or 395 nm LED Curing Systems available from Excelitas Technologies (Waltham, MA). In some cases, the light radiation of step b) (e.g., Step 220) of the method is provided by a light source comprising an LED.

The output of the actinic light source is capable of partially curing (or crosslinking) the uncured composition by chemically activating a suitable photoradical generator present in the composition.

In an exemplary embodiment, a suitable actinic light source produces a spectral output with a peak intensity at a wavelength λ₁ of at least 425 nm, at least 430 nm, at least 435 nm, at least 440 nm, at least 445 nm, or at least 450 nm. In this embodiment, the peak intensity can be at a wavelength λ₁ of up to 480 nm, up to 475 nm, up to 470 nm, up to 465 nm, or up to 460 nm. The excitation dose used to activate the photoradical generator can be at least 200 mJ/cm², at least 250 mJ/cm², at least 300 mJ/cm², at least 350 mJ/cm², or at least 400 mJ/cm². The excitation dose can be up to 6400 mJ/cm², up to 5600 mJ/cm², 4800 mJ/cm², up to 4000 mJ/cm², or up to 3200 mJ/cm².

In some embodiments of the method, the step c) (e.g., Step 230) comprises subjecting the composition to light radiation to initiate foaming of the at least partially cured composition. The step employs an actinic light source that emits light over a distribution of wavelengths that is different from that of the first actinic light source, e.g., providing a characteristic wavelength λ₂ different from the characteristic wavelength λ₁ of the first actinic light source. In preferred embodiments, the wavelength λ₂ is shorter than the wavelength λ₁. The wavelength λ₂ can be non-specific since it is used for the final curing step. In exemplary embodiments, the wavelength λ₂ can be at least 200 nm, at least 250 nm, at least 300 nm, at least 330 nm, or at least 356 nm. The wavelength λ₂ can be up to 380 nm, up to 377 nm, or up to 374 nm. In some cases, unlike the narrow wavelength band used in step b) (e.g., Step 220), the light radiation of step c) (e.g., Step 230) has a wavelength band of greater than 50 nm, 75 nm or greater, 100 nm or greater, 150 nm or greater, 200 nm or greater, or 250 nm or greater, and 500 nm or less.

The (e.g., second) actinic light source could be based on an LED source, as described earlier. Alternatively, this actinic light source could be a UV black light, mercury lamp, or other broad spectrum light source.

A UV black light is a relatively low light intensity source that provides generally 10 mW/cm² or less (as measured in accordance with procedures approved by the United States National Institute of Standards and Technology as, for example, with a UVIMAP UM 365 L-S radiometer manufactured by Electronic Instrumentation & Technology, Inc., Sterling, VA) over a wavelength range of 280 nm to 400 nm.

A mercury lamp is a higher intensity broad-spectrum UV source capable of providing intensities generally greater than 10 mW/cm², and preferably between 15 and 6000 mW/cm². For example, an intensity of 600 mW/cm² and an exposure time of about 1 second may be used successfully. Intensities can range from 0.1 mW/cm² to 6000 mW/cm² and preferably from 0.5 mW/cm² to 3000 mW/cm².

To avoid inadvertently triggering both curing/foaming reactions simultaneously, the (e.g., first) actinic light source emits over wavelengths that are not significantly absorbed by the crosslinker having a photodegradable linkage, chemical blowing agent, or photoacid generator. Where generally monochromatic light sources are used, the two actinic light sources could operate at different wavelengths; for example, they could have respective peak intensities at wavelengths separated by at least 10 nm, at least 15 nm, at least 20 nm, at least 25 nm, or at least 35 nm. The two actinic light sources could have respective peak intensities at wavelengths separated by up to 100 nm, up to 80 nm, up to 60 nm, up to 50 nm, or up to 45 nm.

In some cases, it may be convenient to employ heat instead of (or in addition to) radiation from a second actinic light source. In such embodiments of the method, the step c) (e.g., Step 230) comprises subjecting the composition to heat to initiate foaming of the at least partially cured composition. Chemical blowing agents and crosslinkers comprising photodegradable linkages both also degrade when subjected to heat, thus it is possible to initiate foaming using heat from any suitable source (e.g., an oven, a lamp, a torch, a heat gun, or combinations thereof). The composition can be heated, typically by subjection to a temperature of 40° C. or greater, 50° C., 60° C., 75° C., 90° C., 100° C., 120° C., 130° C., 140° C., 150° C., 160° C., 170° C., or 180° C. or greater; and 250° C., 230° C., 210° C., 200° C., 190° C., 180° C.; such as ranging from 40° C. to 475° C., 40° C. to 350° C., 140° C. to 310° C., or 180° C. to 300° C., inclusive.

The substrate comprises a tape liner or glass substrate. Suitable substrates include for instance and without limitation, a polymeric material, a glass, a ceramic, or a metal. In some embodiments, the substrate comprises a polymeric material selected from polyethylene terephthalate, polyethylene naphthalate, polycarbonate, polyimide, cycloolefin films, poly(methyl methacrylate), polyethylene, polypropylene, polyamides or combinations thereof The substrate is a tape liner that optionally comprises a release material (e.g., a release liner), such as when the adhesive will be transferred to another material or device. Such a release liner is not particularly restricted and could be, for example, any of a number of silicone-coated polyester release liners known in the art.

### Debondable Articles and Methods

In an eleventh aspect, a debondable article is provided. The debondable article comprises:
i) a first substrate comprising a major surface;
ii) a second substrate comprising a major surface; and
iii) the polymeric film of the fifth aspect, wherein the polymeric film is adhered to the major surface of the first substrate and to the major surface of the second substrate.

In a twelfth aspect, a method of debonding an article is provided. The method comprises:
i) obtaining the debondable article of the eleventh aspect;
ii) subjecting the debondable article to light radiation, thereby initiating gas release from the polymeric film and forming a weakened polymeric layer; and
iii) applying a force to the article such that the weakened polymeric layer undergoes selective cohesive failure.

Often, at least one of the first substrate or the second substrate comprises an adhesion promotor on the major surface thereof. Suitable adhesion promoters include chlorinated polyolefins, polyamides, modified acrylic polymers, and modified polymers, such as the primers disclosed in U.S. Pat. No. 5,677,376 (Groves), WO 199815601 (Groves), and WO 1999003907 (Groves), or silanes. The adhesion promoter can also be a plasma primer layer, whereby a plasma, such as oxygen or nitrogen, is applied to the surface of a substrate in order to change the surface chemistry by either oxidizing or reducing the surface.

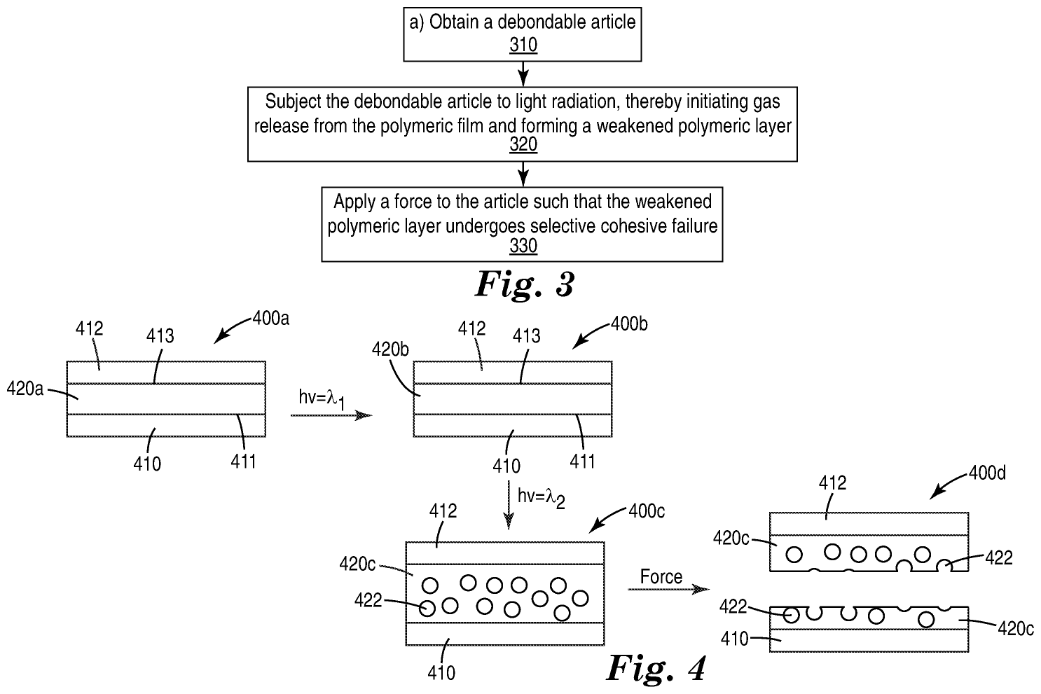

Referring to FIG. 3, a flow chart is provided for an exemplary method of debonding an article. The method comprises Step 310 to obtain a debondable article; Step 320 to subject the debondable article to light radiation, thereby initiating gas release from the polymeric film and forming a weakened polymeric layer; and Step 330 to apply a force to the article such that the weakened polymeric layer undergoes selective cohesive failure. The weakened polymeric layer has at least one of a lower density or a smaller number of crosslinks than the polymeric layer prior to the release of gas from the layer. Preferably, the weakened polymeric layer is a foamed polymeric layer, in which the polymeric layer comprises foam cells.

Referring to FIG. 4, a schematic cross-sectional view is provided depicting an exemplary method of debonding a debondable article. More particularly, an article 400a is shown comprising a first substrate 410 having a major surface 411; a second substrate 412 having a major surface 413; and a composition 420a disposed between the major surface 411 of the first substrate 410 and the major surface 413 of the second substrate 412. The composition 420a is according to the first aspect described in detail above.

Subjecting the composition 420a to actinic radiation (e.g., light having a wavelength of λ₁) initiates polymerization of the composition to provide the debondable article 400b. The debondable article 400b comprises a first substrate 410 having a major surface 411; a second substrate 412 having a major surface 413; and a polymeric film 420b adhered to the major surface 411 of the first substrate 410 and to the major surface 413 of the second substrate 412. The polymeric film 420b comprises a reaction product of the composition 420a.

Subjecting the debondable article 400b to light radiation (e.g., light having a wavelength of λ₂), initiates releasing gas from the polymeric film 420b (e.g., initiating foaming of the polymeric film 420b and forms a weakened (e.g., foamed) polymeric layer 420c in a weakened (e.g., foamed) debondable article 400c. In this embodiment, the weakened polymeric layer 420c comprises a foamed polymeric layer 420c comprising closed cells 422.

During gas release (and optionally foaming), the crosslinker that contains a photodegradable linkage undergoes chain scission, enabling the modulus of the reaction product to be dynamically tuned to better accommodate a foam cell structure. Additionally, a decrease in modulus can also aid in the separation of an adhesive bond.

Next, a force is applied to the weakened (e.g., foamed) debondable article 400c such that the weakened (e.g., foamed) polymeric layer 420c undergoes selective cohesive failure and results in a debonded article 400d. In some cases, a shear force is applied. The debonded article 400d comprises a first substrate 410 comprising a portion of the foamed polymeric layer 420c disposed thereon and a separate second substrate 412 comprising a portion of the foamed polymeric layer 420c disposed thereon. In contrast, without the weakening of the polymeric film, a significantly greater force would be required to separate the two substrates, and such force might risk damaging one or more of the substrates during a separation attempt.

The following Examples are set forth to describe additional features and embodiments of the invention.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise noted or readily apparent from the context, all parts, percentages, ratios, etc. in the Examples and the rest of the specification are by weight.

TABLE 1
Materials List

| DESIGNATION | DESCRIPTION | SOURCE |
|---|---|---|
| V88 | Chemical blowing agent (CBA); 1,1′- | Sigma Aldrich, St |
| | azobis(cyclohexanecarbonitrile) | Louis, MO |
| V601 | Chemical blowing agent; Dimethyl 2,2′- | Combi-blocks, San |
| | azobis(2-methylpropionate) | Diego, CA |
| VA086 | Chemical blowing agent; 2,2′-azobis[2-methyl- | FujiFilm, Richmond, |
| | N-(2-hydroxyethyl)propionamide] | VA |
| IRG651 | Benzyldimethyl ketal photoinitiator obtained | BASF, |
| | under trade designation “IRGACURE 651” | Ludwigshafen |
| | from BASF SE, Ludwigshafen Germany | Germany |
| IRG819 | Bis(2,4,6-trimethylbenzoyl)- | BASF |
| | phenylphosphineoxide photoinitiator, obtained | |
| | under the trade designation “IRGACURE 819” | |
| IRG784 | Titanium, bis(h5-2,4-cyclopentadien-1- | BASF |
| | yl)bis[2,6-difluoro-3-(1H-pyrrol-1-yl)phenyl], | |
| | obtained under the trade designation | |
| | “IRGACURE 784” | |
| CPI6976 | Triarylsulfonium hexafluoroantimonate, 50 wt. | Aceto Corporation, |
| | % in propylene carbonate | Port Washington, NY |
| BA | Butyl acrylate | BASF |
| CN339 | Phenoxyethyl acrylate, obtained under the trade | Sartomer, Exton, PA |
| | designation “CN339” | |
| THFA | Tetrahydrofurfuryl acrylate (V-150) | San Esters, New |
| | | York, NY |
| AA | Acrylic acid | BASF |
| HBA | Hydroxybutyl acrylate | TCI America, |
| | | Portland, OR |
| iBoA | Isobornyl acrylate | TCI America |
| G4188 | Monofunctional urethane acrylate in EHA | Rahn USA Corp, |
| | obtained under the trade designation | Arora, IL |
| | “GENOMER 4188/EHA” | |
| NVP | N-vinyl pyrrolidinone | TCI America |
| E828 | Liquid epoxy resin comprised of diglycidyl | Hexion Inc., |
| | ether of bisphenol A obtained under the trade | Columbus, OH |
| | designation “EPON 828” | |
| E1001F | Solid epoxy resin comprised of diglycidyl ether | Hexion Inc. |
| | of bisphenol A obtained under the trade | |
| | designation “EPON 1011F” | |
| PPG2000 | Arcol PPG 2000 polyether polyol | Covestro, LLC, |
| | | Leverkusen, |
| | | Germany |
| GPTMS | 3-(Glycidoxypropyl) Trimethoxysilane | United Chemical |
| | | Technologies, |
| | | Levittown, PA |
| HDDA | Hexane diol diacrylate, sold under the trade | Sartomer, Exton, PA |
| | designation “SR238” | |
| AcrCl | Acryloyl chloride | Sigma Aldrich |
| TEA | Triethyl amine | ThermoFisher |
| | | Scientific, Waltham, |
| | | MA |
| ACN | Acetonitrile | Sigma Aldrich |
| EtOAc | Ethyl acetate | ThermoFisher |
| | | Scientific |
| MEK | Methyl ethyl ketone | ThermoFisher |
| | | Scientific |
| Ethyl 4- | Benzocaine | Sigma Aldrich |
| aminobenzoate | | |
| HCl | Concentrated hydrochloric acid | EMD Millipore |
| | | Burlington, MA |
| NaNO₃ | Sodium Nitrite | Sigma Aldrich |
| Piperazine | Piperazine | Alfa Aesar, Ward |
| | | Hill, MA |
| K₂CO₃ | Potassium Carbonate | Alfa Aesar |
| Na₂SO₄ | Sodium Sulfate | Alfa Aesar |
| DCM | Dichloromethane | EMD Millipore |
| MeOH | Methanol | VWR, Radnor, PA |
| THF | Tetrahydrofuran | EMD Millipore |
| LAH | Lithium aluminum hydride | Alfa Aesar |
| NaOH | Sodium hydroxide | EMD Millipore |
| CELITE | CELITE 545 filter aid | EMD Millipore |
| DMAP | 4-(dimethylamino)pyridine | Alfa Aesar |
| Methacrylic | Methacrylic anhydride | Alfa Aesar |
| anhydride | | |
| AP1 | Adhesion promotor prepared according to | 3M Company, St. |
| | U.S. Pat. No. 9,790,396 Preparative Example 7. | Paul, MN |
| MeSOH | Methane sulfonic acid, 99% | ThermoFisher |
| CHCl₃ | Chloroform | Sigma Aldrich |
| EHA | 2-Ethylhexyl acrylate | BASF |
| HEMA | (Hydroxyethyl)methacrylate | Sigma Aldrich |

### Test Methods

### 450 nm LED Array

The initial photocuring set-up is comprised of a high-density array of 200 light emitting diodes (LEDs), emitting at a 450 nanometer (nm) wavelength, arranged to provide a minimum uniform irradiance on the order of 250 milliwatts per square centimeter (mW/cm²) over the desired surface area of material to be cured. The Luxeon Z ES series of LEDs (LUMILEDS, Schiphol, Netherlands) was chosen for these experiments due to energy density, efficacy, and spectral width. The array heat sink is engineered to minimize LED output drop due to thermal effects, which can impact irradiance. A constant current source is applied to the array to provide a consistent and repeatable level of photonic energy.

The curing method entails:
1) Position LED array in curing chamber;
2) Place material to be cured at appropriate proximity to the LED array;
3) Optionally, introduce nitrogen into chamber;
4) Apply current to LEDs and irradiate the target material for the appropriate period of time to trigger the photoinitiator and begin the crosslinking process; and
5) Turn off current to LED array.

### Examples

### General Prodecure A: Production of Acrylate Foams

Monomers, crosslinkers and photoactive additives were mixed according to the tables below. If needed, the mixture was placed in a sonication bath to dissolve all solids. The mixtures were covered in foil to prevent premature curing in ambient light.

Resin was added to the bottom of an aluminum weigh pan (100-200 milligrams (mg)) and placed on a shelf in a custom-made nitrogen chamber. If organic solvent was used to formulate the resin, the solvent was first removed by evaporation by setting the pan on an 85° C. hot plate until constant weight (approximately 60 seconds). The nitrogen chamber was custom built from a 12 inch×4 inch (30.5 centimeters (cm)×10.2 cm) aluminum electrical box covered with a monolithic quartz slab. A gasket cut out of silicone rubber was used to seal the edges of the box and the quartz window. Two holes were bored into opposite ends of the electrical box, lengthwise. One hole was used as the nitrogen inlet and the other the outlet. The outlet port was attached to a Series 3000 Trace Oxygen Analyzer (Alpha Omega Instruments, Lincoln, RI). The distance between the resin and the outside face of the quartz window was approximately 1 inch (2.5 cm).

Stage A: The chamber was purged to an oxygen level below 100 parts per million (ppm) and then the resin was exposed to the custom 450 nm LED array with the power supply set to 30 volts (V) and various currents and times.

Stage B: To induce foaming, the resin was exposed to either a 401 nm or 365 nm LED array containing 48 diodes (Clearstone Technologies, Hopkins, MN) at 0.5-1 inch (1.3-2.5 cm), unless otherwise noted, for various times at various power settings open to air. Alternatively, foaming could be induced by moving the resin to an oven.

### General Procedure B: Production of Acrylate/Epdxy Foams

### Preparative Acrylic Mixture 1 (PA-1)

A glass jar was charged with 50 parts each of BA and THFA. IRG651 (0.04 parts) was added and the mixture and swirled until the photoinitiator had dissolved and a homogeneous mixture was obtained. The mixture was then degassed by introducing nitrogen gas into it through a tube inserted through an opening in the jar's cap and bubbling vigorously for at least 5 minutes. While stirring, each mixture was exposed to UV-A light until the mixture achieved a viscosity deemed suitable for coating. The light source was an array of LEDs having a peak emission wavelength of 365 nm. Following UV exposure, air was introduced into the jar.

### Preparation of Acrylate/Epoxy Mixtures

A glass jar was charged with E828 and E1001F. The resulting slurry was heated in an oven set at 135° C. until melted, then stirred until a homogenous mixture was obtained. Optionally, PPG2000 was added with stirring and the mixture was cooled to ambient temperature. PA-1, IRG819, CPI6976, optionally GPTMS, and optionally HDDA were added and the jar was rolled (protected from light exposure) until all components were incorporated. To this homogenous mixture was added an azo chemical blowing agent (CBA). If necessary, the vial was sonicated (up to 10 minutes) and/or shaken (E6010.00 Reciprocal Shaker, Eberbach Corp, Ann Arbor, MI) (for up to 2 hours) using sonication to fully dissolve the solids. The resin was exposed to various light sources as described in General Procedure A (Stages A and B). Then, (Stage C) to accelerate epoxy cure, the resin was placed in an oven set at 70-75° C. for various times as indicated in the table below.

### General Procedure C: Monitoring Curing Using FTIR

A piece of 10 mil (0.254 millimeter (mm)) silicone rubber (Diversified Silicone Products, Santa Fe Springs, CA), with a 0.46 inch (1.17 cm) hole in the center, was placed on top of a 2 inch×3 inch×0.04 inch (5.08 cm×7.62 cm×1 mm) glass slide (VWR, Radnor, Pennsylvania). Several drops of the acrylate/epoxy mixture were deposited into the hole, then a 1 inch×3 inch×0.04 inch (2.54 cm×7.62 cm×1 mm) glass slide (Model 2950 from Thermo Fisher Scientific, Waltham, MA) was applied, sandwiching the liquid between the glass slides. The construction was secured by clamping along the narrow edges using a small metal binder clip (Model 10667CT, Staples Inc. Framingham, MA) at the top and one mini metal binder clip (Model 10666CC, Staples Inc.) at the bottom. Transmission Fourier transform infrared (FTIR) spectra were taken using a Thermo Fisher Scientific NICOLET iS50 infrared spectrophotometer with DTGS KBr detector. Spectra consisted of 16 scans with a resolution of 8 (data spacing=0.964 cm⁻¹) over the range of 7000-4000 cm⁻¹. Double bond conversion was determined by monitoring the decrease in the peak at 4490 cm⁻¹. Epoxy conversion was assessed by monitoring the change in the peak at 4530 cm⁻¹.

### Preparative Example 1

### (PE-1): 2,2′-Azobis[2-methyl-N-(2-acryloylethyl)propionamide]

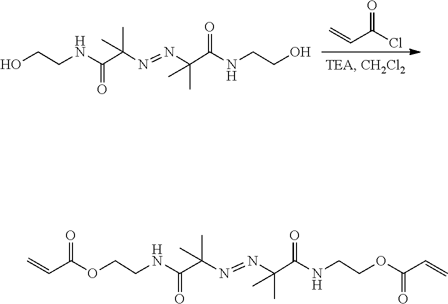

VA086 (2 grams (g), 6.94 millimol (mmol)) was suspended in dry DCM (33 milliliters (mL)). A few crystals of BHT were added and the suspension was sparged with nitrogen. The suspension was then cooled in a dry ice/acetone bath. TEA (6.5 mL, 46.4 mmol) was then added, and subsequently AcrCl was added dropwise (2.2 mL, 27.3 mmol). The solution was stirred and warmed to room temperature over 18 hours. The reaction was then diluted with 200 mL EtOAc and washed with 2×100 mL of 5% sodium bicarbonate and 1×100 mL of brine. The organic phase was dried with MgSO4 and the solvent was removed under vacuum. The residue was purified using silica column chromatography, packed with 60% ethyl acetate/hexanes and eluted with 80% ethyl acetate/hexanes. The product eluted at Rf˜0.3 (UV+KMnO4 stain, 0.8 ethyl acetate/hexanes) and1.95 g of product was obtained (71%, isolated). ¹H-NMR (CDCl₃, 500 MHz): δ 7.30-7.20 (m, 2H), 6.42 (dd, 2H, J=17.3, 1.3 Hz), 6.1 (dd, 2H, J=17.3, 10.5 Hz), 5.87 (dd, 2H, J=10.4, 1.3 Hz), 4.32 (t, 4H, J=5.3 Hz), 3.69 (q, 2H, J=5.4 Hz), 1.33 (s, 12H). 13C{1H}-NMR (CDCl3, 125 MHz): δ 174.0, 166.1, 131.6, 127.8, 74.7, 63.2, 38.7, 22.9.

### Triazine Synthesis

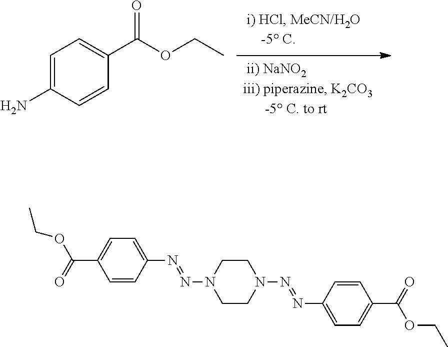 [SMILES: CCOC(=O)c1ccc(N)cc1 ; CCOC(=O)c1ccc(/N=N/N2CCN(/N=N/c3ccc(C(=O)OCC)cc3)CC2)cc1]

### Preparative Example 2

### (PE-2): diethyl 4,4′-((1E,1′E)-piperazine-1,4-diylbis(diazene-2,1-diyl))dibenzoate

A 1 L flask was charged with ethyl 4-aminobenzoate (10 g, 60 mmol), 125 mL of ACN and 375 mL H₂O, followed by 25 mL conc HCl, this was cooled to −5° C. in a ethylene glycol/dry ice bath and slowly over approximately 20 minutes a solution of NaNO₃ (8.35 g, 121 mmol) in 30 mL of H₂O was added. The reaction was then stirred at approximately −10° C. for 30 minutes. The reaction was then poured into a solution of piperazine (2.7 g, 31 mmol) and K₂CO₃ (25 g, 180 mmol) in 150 mL H₂O. This was stirred at room temperature for 1 hour, then diluted with 500 mL DCM. The aqueous layer was washed with 200 mL DCM, then 100 mL DCM. The combined organics were dried over Na₂SO₄, filtered, and concentrated to give a mixture of desired product and starting material. The solid was then suspended in MeOH, filtered, and the resulting solid was washed twice with 100 mL MeOH. A light yellow solid was isolated (12.5 g, 28.5 mmol, 91% yield). ¹H NMR ((CD₃)₂SO, 500 MHz): δ 7.97-7.95 (d, 4H, J=8.6 Hz), 7.51-7.48 (d, 4H, J=8.6 Hz), 4.32-4.28 (q, 4H, J=7.0 Hz), 4.12 (br s, 8H), 1.33-1.31 (t, 6H, J=7.1 Hz). ¹³C NMR ((CD₃)₂SO, 125 MHz): δ 165.5, 153.3, 130.4, 126.8, 120.4, 60.6, 14.3.

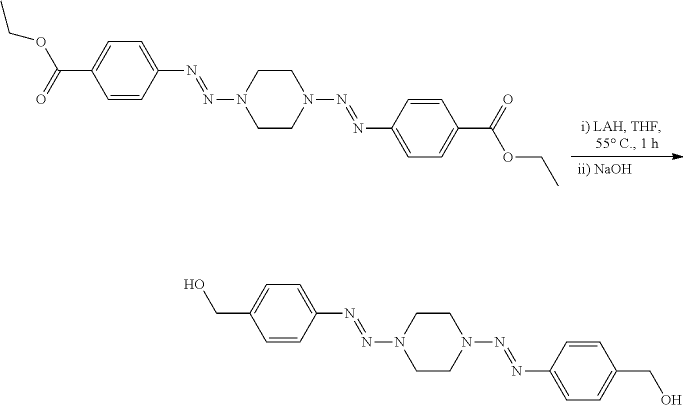 [SMILES: CCOC(=O)c1ccc(/N=N/N2CCN(/N=N/c3ccc(C(=O)OCC)cc3)CC2)cc1 ; OCc1ccc(/N=N/N2CCN(/N=N/c3ccc(CO)cc3)CC2)cc1]

### Preparative Example 3

### (PE-3): (((1E,1′E)-piperazine-1,4-diylbis(diazene-2,1-diyl))bis(4,1-phenylene))dimethanol

A 250 mL flask was charged with the ester (PE-2; 1.4 g, 3.2 mmol) and 32 mL THF, then under N₂ LAH was added (179 mg, 4.7 mmol) and the reaction was heated to 55° C. for 1.5 hour. The reaction was then cooled and quenched with 350 microliters (μL) water, 420 μL 4 M NaOH (aqueous), and 1.05 mL water. The solution and the orange precipitate that resulted were filtered through a pad of CELITE. The filtrate was concentrated and then the resulting solid was added to methanol and filtered, isolating a cream colored solid (900 mg, 2.6 mmol, 82% yield). ¹H NMR ((CD₃)₂SO, 500 MHz): δ 7.38-7.36 (d, 4H, J=8.5 Hz), 7.32-7.31 (d, 4H, J=8.5 Hz), 5.20-5.17 (t, 2H, J=5.8 Hz), 4.49-4.48 (d, 4H, J=5.5 Hz), 3.97 (br s, 8H). ¹³C NMR ((CD₃)₂SO, 125 MHz): δ 148.5, 140.6, 127.2, 120.2, 62.6.

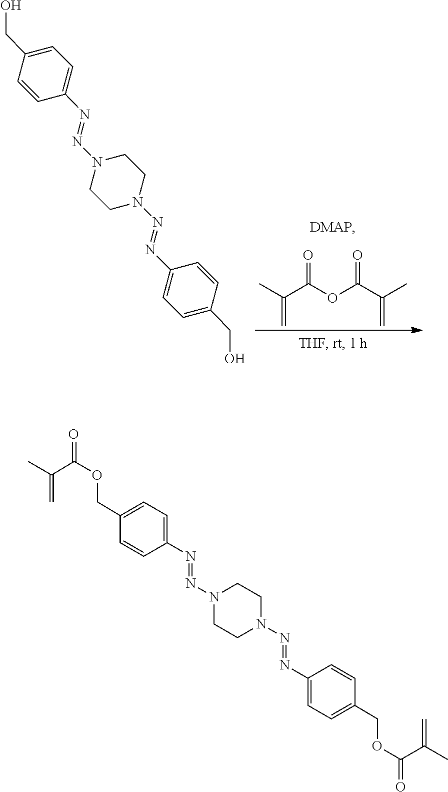 [SMILES: OCc1ccc(/N=N/N2CCN(/N=N/c3ccc(CO)cc3)CC2)cc1 ; C=C(C)C(=O)OC(=O)C(=C)C ; C=C(C)C(=O)OCc1ccc(/N=N/N2CCN(/N=N/c3ccc(COC(=O)C(=C)C)cc3)CC2)cc1]

### Example 19

### (EX-19): (((1E,1′E)-piperazine-1,4-diylbis(diazene-2,1-diyl))bis(4,1-phenylene))bis(methylene) bis(2-methylacrylate)

A 50 mL round bottom was charged with diol (PE-3; 900 mg, 2.54 mmol), 25 mL THF, and DMAP (90 mg, 0.73668 mmol), to this milky yellow heterogeneous solution methacrylic anhydride (1.8 g, 1.7 mL, 12 mmol) was added and the reaction was stirred at room temperature. After 15 minutes the solution was a homogenous clear golden color and was allowed to stir for an additional 1 hour. The reaction was diluted with 25 mL H₂O and 25 mL ethyl acetate, the aqueous layer was washed with an additional 50 mL ethyl acetate, and the combined organics were washed with 25 mL of brine. The organic layer was then dried over Na₂SO₄, filtered and concentrated, then the resulting solid was suspended in MeOH and filtered. The solid was then washed with additional MeOH and dried under vacuum to give a cream colored solid (870 mg, 1.773 mmol, 70% Yield). ¹H NMR ((CD₃)₂SO, 500 MHz): δ 7.40 (s, 8H), 6.07 (t, 2H, J=1.3 Hz), 5.71 (t, 2H, J=1.7 Hz), 5.17 (s, 4H), 4.01 (br s, 8H), 1.90 (t, 6H, J=1.2 Hz). ¹³C NMR ((CD₃)₂SO, 125 MHz): δ 166.9, 150.0, 136.3, 134.3, 129.3, 126.6, 120.9, 66.1, 18.5.

Coating of Glass Plates with API

A 2 inch×3 inch (5.1 cm×7.2 cm) glass microscope slide, previously washed with acetone and then plasma cleaned, was coated with a 2 wt. % solution of API in MEK using a pipette. The coated slide was cured in an oven set at 140° C. for 10 minutes.

### General Procedue for On-Demand Debonding

Four drops of foamable resin was added to a 2 inch×3 inch (5.1 cm×7.2 cm) glass microscope slide coated with AP1. The liquid resin was compressed with a second microscope slide (either as received or after AP1 treatment) such that there was complete overlap of the two slides. The composite was moved to a nitrogen chamber that was purged to an oxygen level below 100 ppm. Then the resin was exposed to a 450 nm LED array containing 200 diodes set to 30 V and 1.0 amp (A) for 15 seconds.

The cured composite was optionally placed in an oven set at 190° C. or irradiated with 48×365 nm LEDs. The two slides were separated by hand using a razor blade as a wedge.

TABLE 2
Formulations of hydrophobic acrylate resins.

| MATERIAL | EX-1 | EX-2 | EX-3 | EX-4 | EX-5 | EX-6 | EX-7 | EX-8 |
|---|---|---|---|---|---|---|---|---|
| BA, pph* | — | — | 7.5 | 10.5 | 11.3 | 38.9 | 31.6 | 31.5 |
| CN339, pph | 11.8 | 11.8 | 14.5 | 21.1 | 23.2 | 43.6 | 63.2 | 62.9 |
| THFA, pph | — | — | — | — | — | 8.6 | — | — |
| PE-1, pph | 11.8 | 11.8 | 7.5 | — | 0.6 | 0.2 | 0.5 | — |
| V88, pph | — | — | — | 3.3 | 3 | 8.6 | — | — |
| V601, pph | — | — | — | — | — | — | 4.5 | 5 |
| IRG819, pph | 0.12 | 0.22 | 0.28 | 0.16 | 0.17 | 0.2 | — | — |
| IRG784, pph | — | — | — | — | — | — | 0.12 | 0.12 |
| MeSOH, pph | — | — | — | — | — | — | 0.06 | 0.06 |
| HDDA, pph | — | — | — | — | — | — | 0.02 | 0.5 |
| CHCl₃, pph | — | — | — | — | 22.7 | — | — | — |
| EtOAc, pph | 76.4 | 76.4 | 70.4 | 64.7 | 39.1 | — | — | — |

*parts per hundred

TABLE 3
Formulation of hydrophilic acrylate resins

| MATERIAL | EX-9 | EX-10 | EX-11 |
|---|---|---|---|
| EHA, pph | 4 | — | — |
| BA, pph | — | 4 | — |
| AA, pph | 0.5 | 0.5 | — |
| HBA, pph | 2 | 2 | — |
| iBoA, pph | 2 | 2 | — |
| G4188, pph | 1 | 1 | — |
| NVP, pph | 0.5 | 0.5 | — |
| HEMA, pph | — | — | 91.5 |
| HDDA, pph | — | — | 0.3 |
| V88, pph | 5 | 5 | — |
| V601, pph | — | — | 4.6 |
| IRG819, pph | 0.02 | 0.02 | — |
| IRG784, pph | — | — | 2.5 |
| MeSOH, pph | — | — | 1.2 |

TABLE 4
Formulation of mixed acrylate/epoxy resins. V601 had much greater
solubility (up to 10 wt. % incorporated) in resin formulation than
V88 (up to 5 wt. % incorporated with significant sonication).

| MATERIAL | CE-1 | EX-12 | EX-13 | EX-14 | EX-15 | EX-16 | EX-17 | EX-18 |
|---|---|---|---|---|---|---|---|---|
| PA-1, pph | 38 | 38 | 38 | 38 | 38 | 44 | 44 | 39 |
| E828, pph | 31 | 31 | 31 | 31 | 31 | 34 | 34 | 31 |
| E1001F, pph | 16 | 16 | 16 | 16 | 16 | 17 | 17 | 15 |
| PPG2000, pph | 12 | 12 | 12 | 12 | 12 | — | — | 12 |
| GPTMS, pph | 1 | 1 | 1 | 1 | 1 | — | — | — |
| CPI6976, pph | 3 | 3 | 3 | 3 | 3 | 3.4 | 3.4 | 3 |
| HDDA, pph | 0.2 | 0.2 | 0.2 | 0.2 | 0.2 | — | — | — |
| IRG819, pph | 0.32 | 0.32 | 0.32 | 0.32 | 0.32 | 0.36 | 0.36 | 0.32 |
| V88, pph | — | 5 | 2 | — | — | — | — | — |
| V601, pph | — | — | — | 5 | 2.5 | 2.5 | 5 | 2.5 |

TABLE 5
Resin cure with 450 nm LED array at 1 inch (2.5 cm) and 30 V power (Stage A).

| | EXPOSURE TIME, | | CURRENT, | |
|---|---|---|---|---|
| SAMPLE | seconds | | Amps | RESULT |
| EX-1a | 15 | s | 0.1 | Incomplete cure, still liquid |
| EX-1b | 30 | s | 0.5 | Incomplete cure, still liquid |
| EX-1c | 30 | s | 1.0 | Almost cured, bottom of resin |
| | | | | still contains uncured monomer |
| EX-1d | 60 | s | 1.0 | Fully cured, resin foamed |
| EX-2a | 5 | s | 1.0 | Incomplete cure, still liquid |
| EX-2b | 15 | s | 1.0 | Fully cured, no gas bubbles |
| EX-2c | 60 | s | 0.1 | Incomplete cure, polymer skin |

TABLE 6
Stage B foaming of acrylate films previously cured with 450
nm light for 15-20 seconds at 30 V and 1.0 A during Stage A.

| | FOAMING | FOAMING | |
|---|---|---|---|
| SAMPLE | METHOD | CONDITIONS | RESULTS |
| EX-3a | Oven | 15 seconds at | Foam, resulting resin more flexible after |
| | | 190° C. | Stage B foaming then after Stage A curing |
| EX-3b | 48 × 401 nm | 45 seconds at | Foam, cell structure is more uniform with |
| | LED | 50% power | smaller bubbles than thermal foaming |
| EX-4a | Oven | 15 seconds at | Gas release, foam collapsed before |
| | | 190° C. | removal from oven |
| EX-4b | 48 × 401 nm | 30 seconds at | Foam |
| | LED | 50% power | |
| EX-4c | 48 × 365 nm | 30 seconds at | Foam |
| | LED | 50% power | |
| EX-4d | 48 × 365 nm | 30 seconds at | No foam |
| | LED | 25% power | |
| EX-4e | 48 × 365 nm | 30 seconds at | No foam |
| | LED | 10% power | |
| EX-5a | 48 × 401 nm | 40 seconds at | Foam |
| | LED | 90% power | |
| EX-5b | 48 × 365 nm | 45 seconds at | Foam |
| | LED | 75% power | |
| EX-6a | 48 × 365 nm | 30 seconds at | Foam |
| | LED | 75% power | |
| EX-9a | 48 × 365 nm | 30 seconds at | Foam |
| | LED | 75% power | |

TABLE 7
Stage B foaming of acrylate films cured with 450 nm
light for 6 min at 24.9 V and 0.1 A during Stage A.

| | FOAMING | FOAMING | |
|---|---|---|---|
| SAMPLE | METHOD | CONDITIONS | RESULTS |
| EX-7a | 48 × 401 nm | 15 seconds at | Foam |
| | LED | 80% power | |
| EX-8a | 48 × 401 nm | 2 × 10 seconds at | Foam |
| | LED | 80% power | |
| EX-11a | 48 × 401 nm | 2 × 10 seconds at | Foam |
| | LED | 90% power | |

TABLE 8
Debonding of glass microscope slides adhered using foamable acrylate resin
EX-6. API is an adhesion promotor that will react into the foamable resin.
When API is used, the network is covalently attached to the substrate.

| | COATING ON | COATING ON | FOAMING | |
|---|---|---|---|---|
| SAMPLE | SLIDE 1 | SLIDE 2 | CONDITIONS | RESULTS |
| EX-6b | AP1 | AP1 | None | Glass cracked before |
| | | | | slides separated |
| EX-6c | AP1 | None | None | Could separate slides with |
| | | | | great effort, working razor |
| | | | | around the seams of the |
| | | | | composite |
| EX-6d | AP1 | AP1 | 365 nm LED, 1 | Clean separation of slides |
| | | | inch (2.5 cm), | using razor. Qualitatively |
| | | | 30 seconds, | less effort then Sample |
| | | | 95% power | EX-6c. |
| EX-6e | AP1 | AP1 | 365 nm LED, 1 | Clean separation of slides. |
| | | | inch (2.5 cm), | Bond could be separated |
| | | | 60 seconds, | by hand |
| | | | 95% power | |

TABLE 9
Foaming of mixed acrylate/epoxy resins. Stage A curing was 15 seconds at 450
nm (30 V, 1 A) at a 1 inch (2.5 cm) working distance. These conditions completely
cured the acrylate in all compositions as observed by IR (ν = 4490 cm⁻¹).
Extent of epoxy cure after Stage C was also assessed by IR (ν = 4530 cm⁻¹).

| | STAGE B | STAGE C | EPOXY | | |
|---|---|---|---|---|---|
| SAMPLE | CONDITIONS | CONDITIONS | CURE | FOAM | NOTES |
| CE-1a | 15 seconds at 365 | 10 minutes at | Full cure | No | Hard and non- |
| | nm, 75% power, 1 | 75° C. | | | tacky, amber in |
| | inch | | | | color |
| CE-1b | 30 seconds at 365 | 10 minutes at | Full cure | No | Hard and non- |
| | nm, 75% power, 1 | 75° C. | | | tacky, amber in |
| | inch | | | | color |
| CE-1c | 30 seconds at 365 | 60 minutes at | Full cure | No | Hard and non- |
| | nm, 75% power, 1 | 75° C. | | | tacky, very dark |
| | inch | | | | brown |
| EX-12a | 30 seconds at 365 | 8 minutes at | 5% | Yes | Soft and tacky |
| | nm, 75% power, 1 | 75° C. | cure | | |
| | inch | | | | |
| EX-12b | 30 seconds at 365 | 120 minutes at | 25% | Yes | Soft and tacky |
| | nm, 75% power, 1 | 75° C. | cure | | |
| | inch | | | | |
| EX-13a | 30 seconds at 365 | 8 minutes at | 30% | Yes | Soft and tacky, |
| | nm, 75% power, 1 | 75° C. | cure | | but less then EX- |
| | inch | | | | 9 under same |
| | | | | | conditions |
| EX-13b | 30 seconds at 365 | 120 minutes at | 55% | Yes | Soft and tacky, |
| | nm, 75% power, 1 | 75° C. | cure | | but less then EX- |
| | inch | | | | 9 under same |
| | | | | | conditions |
| EX-14a | 15 seconds at 365 | 10 minutes at | 40% | Yes | Soft, clear |
| | nm, 75% power, 1 | 75° C. | | | |
| | inch | | | | |
| EX-14b | 15 seconds at 365 | 60 minutes at | 80% | Yes | Soft, off white |
| | nm, 75% power, 1 | 75° C. | | | |
| | inch | | | | |
| EX-14c | 30 seconds at 365 | 10 minutes at | 50% | Yes | Soft, very light |
| | nm, 75% power, 1 | 75° C. | | | tan |
| | inch | | | | |
| EX-14d | 30 seconds at 365 | 60 minutes at | Complete | Yes | Non-tacky, tan |
| | nm, 75% power, 1 | 75° C. | cure | | |
| | inch | | | | |
| EX-15a | 15 seconds at 365 | 10 minutes at | Complete | Yes | Non-tacky, light |
| | nm, 75% power, 1 | 75° C. | cure | | brown |
| | inch | | | | |
| EX-15b | 15 seconds at 365 | 60 minutes at | Complete | Yes | Non-tacky, dark |
| | nm, 75% power, 1 | 75° C. | cure | | purple/maroon |
| | inch | | | | |
| EX-16a | 15 seconds each | 30 minutes at | Complete | Yes | Light yellow |
| | (front & back) at | 75° C. | cure | | |
| | 365 nm, 75% | | | | |
| | power, 1 inch | | | | |
| EX-16b | 15 seconds each | 96 hours at | Complete | Yes | White foam |
| | (front & back) at | 21° C. | cure | | |
| | 365 nm, 75% | | | | |
| | power, 1 inch | | | | |
| EX-17 | 15 seconds each | 96 hours at | >98% | Yes | Colorless foam |
| | (front and back) at | 21° C. | cure | | |
| | 365 nm, 75% | | | | |
| | power, 1 inch | | | | |
| EX-18 | 15 seconds each | 9 hours at | Complete | Yes | Colorless foam |
| | (front and back) at | 21° C. | cure | | |
| | 365 nm, 75% | | | | |
| | power, 1 inch | | | | |

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A composition comprising:
a) a free-radically reactive component;
b) a crosslinker comprising a photodegradable linkage that releases nitrogen gas upon decomposition; and
c) a photoradical generator.

2. The composition of claim 1, wherein there is at least one wavelength of light at which the photoradical generator degrades that is different from the wavelengths of light at which the photodegradable linkage of the crosslinker degrades.

3. The composition of claim 1, wherein the crosslinker is of Formula (I) or Formula (II): 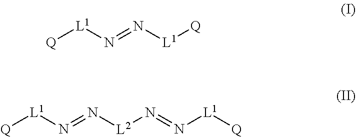
wherein Q is independently an ethylenically unsaturated group;
wherein L¹ is independently a divalent (hetero)hydrocarbylene group; and wherein L² is a multivalent (hetero)hydrocarbylene group.

4. A composition comprising:
a) a free-radically reactive component;
b) an epoxy component;
c) a chemical blowing agent;
d) a photoradical generator; and
e) a photoacid generator,
wherein there is at least one wavelength of light at which the photoradical generator degrades that is different from the wavelengths of light at which the chemical blowing agent degrades.

5. The composition of claim 1, wherein the photoradical generator comprises a visible light initiated free-radical photoinitiator.

6. The composition of any of claim 1, wherein the free-radically reactive component comprises at least one ethylenically unsaturated group comprising a vinyl group, an alkenyl group, a (meth)acrylic group, a (meth)acryl group, or combinations thereof.

7. A polymeric film comprising a reaction product of a composition comprising:
a) a free-radically reactive component;
b) a crosslinker comprising a photodegradable linkage; and
c) a photoradical generator,
wherein the photodegradable linkage of the crosslinker is present in the reaction product.

8. A polymeric film comprising a reaction product of a composition comprising:
a) a free-radically reactive component;
b) an epoxy component;
c) a chemical blowing agent;
d) a photoradical generator; and
e) a photoacid generator,
wherein the chemical blowing agent is present in the reaction product, and wherein there is at least one wavelength of light at which the photoradical generator degrades that is different from the wavelengths of light at which the chemical blowing agent degrades.

9. The polymeric film of claim 8, wherein the free-radically reactive component comprises at least one of a crosslinker or a monomer comprising at least one ethylenically unsaturated group comprising a vinyl group, an alkenyl group, a (meth)acrylic group, a (meth)acryl group, or combinations thereof.

10. A debondable article comprising:
i) a first substrate comprising a major surface;
ii) a second substrate comprising a major surface; and
iii) the polymeric film of claim 7, wherein the polymeric film is adhered to the major surface of the first substrate and to the major surface of the second substrate.

11. A method of debonding an article, the method comprising:
i) obtaining the debondable article of claim 10;
ii) subjecting the debondable article to light radiation, thereby initiating gas release from the polymeric film and forming a weakened polymeric layer; and
iii) applying a force to the article such that the weakened polymeric layer undergoes selective cohesive failure.

12. A foam composition comprising:
a) a foamed polymeric matrix, wherein the polymeric matrix comprises a reaction product of a composition comprising:
i) a free-radically reactive component;
ii) a crosslinker comprising a photodegradable linkage; and
iii) a photoradical generator
b) fragments of the crosslinker; and
c) fragments of the photoradical generator.

13. A foam composition comprising:
a) a foamed thermoset polymeric matrix, wherein the thermoset polymeric matrix comprises a reaction product of a composition comprising:
i) a free-radically reactive component;
ii) an epoxy component;
iii) a chemical blowing agent;
iv) a photoradical generator; and
v) a photoacid generator
wherein there is at least one wavelength of light at which the photoradical generator degrades that is different from the wavelengths of light at which the chemical blowing agent degrades;
b) fragments of the chemical blowing agent;
c) fragments of the photoradical generator; and
d) fragments of the photoacid generator.

14. An article comprising a substrate and the composition of claim 1 disposed on the substrate.

15. A foam adhesive comprising a substrate and the foam composition of claim 12 disposed on the substrate.

16. A method of making a foam composition comprising a foamed polymeric matrix, the method comprising:
a) dispensing a composition onto a substrate;
b) subjecting the composition to light radiation having a wavelength band of 50 nanometers or less, thereby initiating polymerization of the composition; and
c) subjecting the composition to light and/or heat radiation, wherein the light radiation has at least one wavelength that is outside the wavelength band of the light radiation of step b), thereby initiating foaming of the composition.

17. The method of claim 16, wherein the composition comprises:
i) a free-radically reactive component;
ii) a crosslinker comprising a photodegradable linkage; and
iii) a photoradical generator.

18. The method of claim 16, wherein the composition comprises:
i) a free-radically reactive component;
ii) an epoxy component;
iii) a chemical blowing agent;
iv) a photoradical generator; and
v) a photoacid generator
wherein there is at least one wavelength of light at which the photoradical generator degrades that is different from the wavelengths of light at which the chemical blowing agent degrades.

19. The method of claim 16, wherein the composition comprises:
i) a free-radically reactive component;
ii) a photoradical generator; and
iii) a chemical blowing agent.

20. A crosslinker of Formula II: 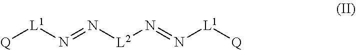
wherein Q is independently an ethylenically unsaturated group; wherein L¹ is independently a divalent (hetero)hydrocarbylene group; and wherein L² is a multivalent (hetero)hydrocarbylene group.
